(19) United States
(12) Patent Application Publication
(10) Pub. No.: US 2015/0079448 A1
(43) Pub. Date: Mar. 19, 2015

(54) NONAQUEOUS ELECTROLYTE BATTERY

(71) Applicant: Kabushiki Kaisha Toshiba, Minato-ku (JP)

(72) Inventors: Yoshiyuki ISOZAKI, Tokyo (JP); Norio Takami, Yokohama (JP)

(73) Assignee: Kabushiki Kaisha Toshiba, Minato-ku (JP)

(21) Appl. No.: 14/487,227

(22) Filed: Sep. 16, 2014

(30) Foreign Application Priority Data
Sep. 17, 2013 (JP) 2013-192071

(51) Int. Cl. H01M 2/06; H01M 4/485; H01M 2/20

(52) U.S. Cl. CPC H01M 2/06; H01M 2/202; H01M 4/485
USPC 429/121; 429/178

(57) ABSTRACT

According to one embodiment, there is provided a nonaqueous electrolyte battery. The battery includes an electrode group, an electrode lead electrically connected to the electrode group, and a case. The case includes a housing part, a sealed part formed in a peripheral portion, and a lead-sandwiching part positioned between the housing part and the sealed part. The lead-sandwiching part includes a first zone and a second zone. The lead-sandwiching part sandwiches the electrode lead between the first zone and the second zone. At least one of the first zone and the second zone of the lead-sandwiching part includes an opening part. At least a part of the electrode lead is exposed through the opening part.

### CROSS-REFERENCE TO RELATED APPLICATIONS

This application is based upon and claims the benefit of priority from Japanese Patent Application No. 2013-192071, filed Sep. 17, 2013, the entire contents of which are incorporated herein by reference.

### FIELD

Embodiments described herein relate generally to a nonaqueous electrolyte battery, a battery module, and a battery apparatus.

### BACKGROUND

In recent years, a nonaqueous electrolyte battery using a substance which can absorb and release lithium ions as a positive electrode material and a negative electrode material is used for a variety of applications as power sources for mobile devices such as a mobile phone, a notebook computer, and a smart phone, an electric vehicle, an electric assistant bicycle, and a UPS (uninterruptible power supply), or the like. Recently, applications using a nonaqueous electrolyte battery in an electrical storage system in which the nonaqueous electrolyte battery is combined with solar power generation and wind power generation or the like are rapidly increasing due to growing interest in environmental problems such as global warming, and responses to large-scale disasters or the like.

As applications spread over a wide range, specifications required for the battery also differ from those of a conventional mobile device. In the case of the electrical storage application, features such as ease of maintenance and a long useful life, as well as high safety, high energy density (miniaturization and weight saving), and low cost are required. For this reason, it is necessary to prevent leakage of a nonaqueous electrolyte to the exterior and deterioration of the nonaqueous electrolyte caused by infiltration of moisture from the exterior of the battery.

Incidentally, the use of a case formed of a plurality of films instead of a conventional metal can for the purpose of further thinning and weight-saving for a case housing a positive electrode and a negative electrode has advanced. Examples of a case formed of a plurality of films include a composite film including an external-impact-protection film typified by a nylon film and serving as an outermost layer, a metal layer typified by an aluminum foil and disposed in the middle for the purpose of moisture prevention and light interception, and a heat-fusible resin film serving as an innermost layer and sealing an electrode group and an electrolyte.

As a case formed of a film material, one which includes a rectangular formed part (rectangular cup-shaped part) formed by deep drawing press processing, peripheral parts horizontally extending from four sides of the cup-shaped part, and a flat-plate part connected to one of the peripheral parts is known. An electrode group which includes a positive electrode and a negative electrode which can absorb and release lithium ions, and a separator or a lithium-ion-conductive solid electrolyte layer disposed between the electrodes is housed in the cup part of the case. A positive electrode terminal connected to the positive electrode of the electrode group and a negative electrode terminal connected to the negative electrode of the electrode group extend to the outside through one or two of the peripheral parts excluding the peripheral part connected to the flat plate part of the case. The heat-fusible resin films are provided on the peripheral parts of the case. When the flat plate part of the case is bent by 180 degrees, the heat-fusible resin films are opposed to each other. A thermoplastic insulating film having a metal adhesive property is disposed on each of the both sides of the heat-fusible resin film in the portion from which the terminal extends. Alternatively, a thermoplastic insulating film having a metal adhesive property is previously disposed on the heat-sealed portion of the terminal. The electrode group is airtightly housed in the exterior member by bending the flat plate part of the case by 180 degrees, and heat-sealing the three peripheral parts excluding the peripheral part which is formed by the bending described above.

However, when the nonaqueous electrolyte battery including the case formed of the film material is placed in a high-temperature and high-humidity condition for a long period of time, the nonaqueous electrolyte battery has the following drawback: moisture may infiltrate from the heat-seated portion of the case. When moisture infiltrates, the following defect is caused: strong acid such as hydrofluoric acid is generated by the decomposition of the electrolyte, which causes deterioration of the adhesive properties of the thermoplastic films respectively disposed between the case and the positive electrode terminal and between the case and the negative electrode terminal. This causes deterioration in the airtightness of the case. As a result, liquid leakage may be caused.

### BRIEF DESCRIPTION OF THE DRAWINGS

FIG. 1 is a schematic plan transparent view of a nonaqueous electrolyte battery of a first example according to a first embodiment;

FIG. 2 is a schematic sectional view taken along line II-II of the nonaqueous electrolyte battery shown in FIG. 1;

FIG. 3 is a schematic perspective view of an electrode group included in the nonaqueous electrolyte battery shown in FIG. 1;

FIG. 4 is an enlarged sectional view of part A of FIG. 3;

FIG. 5 is a schematic development perspective view of a case included in the nonaqueous electrolyte battery of the first example according to the first embodiment;

FIG. 6 is a schematic plan transparent view of a nonaqueous electrolyte battery of a second example according to the first embodiment;

FIG. 7 is a schematic perspective view of a nonaqueous electrolyte battery of a third example according to the first embodiment;

FIG. 8 is a schematic sectional view taken along line VIII-VIII of the nonaqueous electrolyte battery shown in FIG. 7;

FIG. 9 is a schematic perspective view before a bent part is formed in a lead-sandwiching part of the nonaqueous electrolyte battery shown in FIGS. 7 and 8;

FIG. 10 is a schematic perspective view of a battery module of a first example according to a second embodiment;

FIG. 11 is a schematic plan view of the battery module shown in FIG. 10;

FIG. 12 is an enlarged transparent view of a portion XII of FIG. 11;

FIG. 13 is a schematic perspective view of a battery module of a second example according to the second embodiment;

FIG. 14 is a schematic sectional view taken along line XIV-XIV of the battery module shown in FIG. 13;

FIG. 15 is a schematic perspective view of a battery module of a third example according to the second embodiment;

FIG. 16 is a schematic sectional view taken along line XVI-XVI of the battery module shown in FIG. 15;

FIG. 17 is a schematic exploded perspective view of a battery apparatus of an example according to a third embodiment;

FIG. 18 is a schematic sectional view taken along line XVIII-XVIII of the battery apparatus shown in FIG. 17;

FIG. 19 is a schematic plan view of a nonaqueous electrolyte battery of Example;

FIG. 20 is a schematic plan view of a nonaqueous electrolyte battery of Comparative Example 3;

FIG. 21 is a schematic sectional view taken along line XXI-XXI of the nonaqueous electrolyte battery shown in FIG. 20; and

FIG. 22 is a schematic side view of the nonaqueous electrolyte battery shown in FIGS. 20 and 21, and observed from an observation direction v.p. shown in FIG. 21.

### DETAILED DESCRIPTION

In general, according to one embodiment, there is provided a nonaqueous electrolyte battery. The nonaqueous electrolyte battery includes an electrode group, an electrode lead electrically connected to the electrode group, and a case. The case includes a housing part, a sealed part formed in a peripheral portion of the case, and a lead-sandwiching part. The lead-sandwiching part is positioned between the housing part and the sealed part. The lead-sandwiching part includes a first zone and a second zone. The lead-sandwiching part sandwiches the electrode lead between the first zone and the second zone. The housing part of the case houses the electrode group. At least one of the first zone and the second zone of the lead-sandwiching part includes an opening part. At least a part of the electrode lead is exposed through the opening part.

The embodiments will be explained below with reference to the drawings. In this case, the structures common to all embodiments are represented by the same symbols and duplicated explanations will be omitted. Also, each drawing is a typical view for explaining the embodiments and for promoting the understanding of the embodiments. Though there are parts different from an actual device in shape, dimension and ratio, these structural designs may be properly changed taking the following explanations and known technologies into consideration.

### First Embodiment

According to first embodiment, there is provided a nonaqueous electrolyte battery. The nonaqueous electrolyte battery includes an electrode group, an electrode lead electrically connected to the electrode group, and a case. The case includes a housing part, a sealed part formed in a peripheral part, and a lead-sandwiching part. The lead-sandwiching part is positioned between the housing part and the sealed part. The lead-sandwiching part includes a first zone and a second zone. The lead-sandwiching part sandwiches the electrode lead between the first zone and the second zone. The housing part of the case houses the electrode group. At least one of the first zone and the second zone of the lead-sandwiching part includes an opening part. At least a part of the electrode lead is exposed through the opening part.

The nonaqueous electrolyte battery according to the first embodiment can prevent the electrode group from being in contact with moisture or the like contained in the external atmosphere (e.g., air) of the nonaqueous electrolyte battery, which will be described below.

When the opening part through which at least a part of the electrode lead is exposed is formed in the housing part of the case, moisture contained in external air may infiltrate into the housing part through the opening part. Thus, the infiltrating moisture may reach the electrode group housed in the housing part.

On the other hand, in the nonaqueous electrolyte battery according to the first embodiment, the opening part through which at least a part of the electrode lead is exposed is formed in the lead-sandwiching part positioned between the housing part and the sealed part. The lead-sandwiching part sandwiches the electrode lead between the first zone and the second zone. Therefore, there is no space which permits the penetration of the moisture between the first zone and the electrode lead and between the second zone and the electrode lead. Therefore, even if the moisture contained in the external air infiltrates into the lead-sandwiching part through the opening part, the electrode lead, and the first zone and the second zone of the lead-sandwiching part sandwiching the electrode lead therebetween can prevent moisture penetration between them.

Thus, since the nonaqueous electrolyte battery according to the first embodiment can prevent the penetration of the moisture through the lead-sandwiching part, the nonaqueous electrolyte battery can prevent the moisture contained in the external air from reaching the electrode group. Therefore, the nonaqueous electrolyte battery according to the first embodiment can prevent the contact of the electrode group with the moisture contained in the external air.

Thus, since the nonaqueous electrolyte battery according to the first embodiment can prevent moisture contact occurring in the electrode group, the nonaqueous electrolyte battery can prevent deterioration of the electrode group, for example, expansion of the electrode group over a long period. Based on this, the nonaqueous electrolyte battery according to the first embodiment can exhibit a long useful life.

Furthermore, in the lead-sandwiching part, a part of the electrode lead electrically connected to the electrode group is exposed to the outside through the opening part formed in one of the first zone and the second zone. Therefore, the nonaqueous electrolyte battery according to the first embodiment can easily and certainly obtain electrical connection between the nonaqueous electrolyte battery and an electronic device and/or other battery.

In the nonaqueous electrolyte battery according to the first embodiment, the electrode lead is preferably heat-sealed to the periphery of the opening part formed in the lead-sandwiching part.

A heat seal provided in the periphery of the opening part can prevent the moisture from infiltrating into the lead-sandwiching part of the nonaqueous electrolyte battery through the opening part.

A nonaqueous electrolyte battery according to the first embodiment in which the electrode lead is heat-sealed to the periphery of the opening part formed in the lead-sandwiching part can be produced while preventing stress from being generated in the heat seal. The heat seal provided between the periphery of the opening part of the lead-sandwiching part and the electrode lead while preventing the stress from being generated can show a sufficient sealing property.

On the other hand, if the heat seal is perforated or the heat seal is penetrated through by screwing it, stress is inevitably generated in the heat seal. If stress is generated in the heat seal, the sealing property may be deteriorated. Therefore, in the nonaqueous electrolyte battery requiring the perforating the heat seal or penetrating through the heat seal by the screwing it in a production process, the heat seal may have a poor sealing property.

Thus, the nonaqueous electrolyte battery according to the first embodiment in which the electrode lead is heat-sealed to the periphery of the opening part formed in the lead-sandwiching part includes a heat seal which can have a more excellent sealing property than that of the heat seal in which the stress is generated. The nonaqueous electrolyte battery according to the first embodiment can further prevent the moisture from infiltrating into the lead-sandwiching part of the nonaqueous electrolyte battery through the opening part. Eventually, the nonaqueous electrolyte battery can further prevent the moisture contact of the electrode group housed in the housing part of the case.

In the nonaqueous electrolyte battery according to the first embodiment, the first zone of the lead-sandwiching part can include a first insulating member being in contact with the electrode lead. Also, the second zone of the lead-sandwiching part can include a second insulating member being in contact with the electrode lead.

In the nonaqueous electrolyte battery according to the first embodiment, the sealed part is preferably sealed by seam welding. The nonaqueous electrolyte battery can prevent the moisture penetration through the sealed part. Since such a nonaqueous electrolyte battery can further prevent the moisture contact of the electrode group, the nonaqueous electrolyte battery can prevent the deterioration of the electrode group, for example, the expansion of the electrode group over a further long period.

The nonaqueous electrolyte battery according to the first embodiment can be variously modified, and is not limited to a specific aspect.

For example, the shape of the opening part formed in at least one of the first zone and the second zone of the lead-sandwiching part of the case is not particularly limited. The opening part can have a circular or rectangular plane shape, for example.

The first insulating member which may be included in the first zone of the lead-sandwiching part of the case can include, for example, a thermoplastic resin layer formed on the inner surface of the case and/or an additional insulating member. Similarly, the second insulating member which may be included in the second zone of the lead-sandwiching part of the case can include, for example, a thermoplastic resin layer formed on the inner surface of the case and/or an additional insulating member. Examples of the additional insulating member include an insulating ring or insulating member provided in contact with the periphery of the opening part formed in at least one of the first zone and the second zone of the lead-sandwiching part.

A metal case made of stainless steel, stainless steel with nickel-plating, or a nickel-plated steel plate or the like can be used as the case. Particularly, stainless steel can show a higher strength than that of a case made of an aluminum laminate film or the like, and particularly a higher tensile strength. Therefore, a nonaqueous electrolyte battery according to the first embodiment including the case made of stainless steel can have a larger size than that of a battery including a case made of an aluminum laminate film. The stainless steel has excellent corrosion resistance. Therefore, the nonaqueous electrolyte battery according to the first embodiment including a case made of stainless steel can also show high durability.

Next, a nonaqueous electrolyte battery according to a first embodiment will be described in detail.

An electrode group can retain a nonaqueous electrolyte. The nonaqueous electrolyte can also be housed in a housing part of a case along with the electrode group.

The nonaqueous electrolyte battery according to the first embodiment can also prevent leakage of the nonaqueous electrolyte through an opening part formed in a lead-sandwiching part, that is, leakage of the nonaqueous electrolyte to the exterior of the battery from the interior portion of the battery. Particularly, since the nonaqueous electrolyte battery according to the first embodiment in which an electrode lead is heat-sealed to the periphery of the opening part formed in the lead-sandwiching part exhibits a good sealing property, the nonaqueous electrolyte battery can further prevent leakage of the nonaqueous electrolyte to the exterior of the battery from the interior portion of the battery.

The electrode group may include a positive electrode and a negative electrode. Furthermore, the electrode group can also include a separator provided between the positive electrode and the negative electrode. The electrode group can adopt various structures. For example, the electrode group can adopt a stack structure. The stack structure is a structure where a positive electrode and a negative electrode are stacked with a separator sandwiched therebetween. Alternatively, the electrode group can adopt a wound-type structure. The wound-type structure is a structure where an assembly formed by stacking a band-like positive electrode and a band-like negative electrode with a separator sandwiched therebetween is wound. Alternatively, the electrode group can be produced by housing a positive electrode and a negative electrode in a bag-like separator and alternately stacking the positive electrode and the negative electrode. Alternatively, the electrode group can be produced by alternately inserting positive electrodes and negative electrodes in a band-like separator which is folded in a zigzag fashion.

The positive electrode can include a positive electrode current collector and a positive electrode material layer formed on the positive electrode current collector. The positive electrode material layer may be formed on both surfaces of the positive electrode current collector, or may be formed only on one surface of the positive electrode current collector. The positive electrode current collector may include a positive-electrode-material-layer-non-supporting part on neither surface of which the positive electrode material layer is formed.

The positive electrode material layer can contain a positive electrode active material. The positive electrode material layer can further contain a conductive agent and a binder. The conductive agent can be mixed in order to improve a current-collecting performance and to suppress the contact resistance between the positive electrode active material and the positive electrode current collector. The binder can be mixed in order to fill the gaps of the dispersed positive electrode active materials and also to bind the positive electrode active material with the positive electrode current collector.

The positive electrode can be connected to the electrode lead, that is, a positive electrode lead at the positive-electrode-material-layer-non-supporting part of the positive electrode current collector, for example. The positive electrode and the positive electrode lead can be connected by, for example, welding.

The negative electrode can include a negative electrode current collector and a negative electrode material layer formed on the negative electrode current collector. The negative electrode material layer may be formed on both surfaces of the negative electrode current collector, or may be formed only on one surface of the negative electrode current collector. The negative electrode current collector may include a negative-electrode-material-layer non-supporting part on neither surface of which the negative electrode material layer is formed.

The negative electrode material layer can contain a negative electrode active material. The negative electrode material layer can further contain a conductive agent and a binder. The conductive agent can be mixed in order to improve a current-collecting performance and to suppress the contact resistance between the negative electrode active material and the negative electrode current collector. The binder can be mixed in order to fill the gaps of the dispersed negative electrode active materials and also to bind the negative electrode active material with the negative electrode current collector.

The negative electrode can be connected to the electrode lead, that is, a negative electrode lead at the negative-electrode-material-layer non-supporting part of the negative electrode current collector, for example. The negative electrode and the negative electrode lead can be connected by, for example, welding.

Hereinafter, members and materials which can be used in the nonaqueous electrolyte according to the first embodiment will be described.

[1] Negative Electrode

A negative electrode can be prepared by coating a negative electrode material paste prepared by dispersing, for example, a negative electrode active material, a conductive agent, and a binder in a suitable solvent, on one surface or both surfaces of a negative electrode current collector, and drying the negative electrode material paste. The negative electrode can also be pressed after drying.

Examples of the negative electrode active material include a carbonaceous material, a metal oxide, a metal sulfide, a metal nitride, an alloy, and a light metal, which can absorb and release lithium ions.

Examples the carbonaceous material which can absorb and release lithium ions include coke, carbon fiber, carbon material obtained by the pyrolytic of the gaseous carbonaceous substance, graphite, a resin-baked body, a baked body of mesophase pitch-based carbon fiber, or a baked body of mesophase spherical carbon. Particularly, mesophase pitch-based carbon fiber or mesophase spherical carbon which has been graphitized at 2,500° C. or higher is preferably used since the electrode capacity can be increased.

Examples of the metal oxide include a titanium-containing metal composite oxide, tin oxides such as SnB_{0.4}P_{0.6}O_{3.1} and SnSiO₃, a silicon-based oxide such as SiO, and a tungsten-based oxide such as WO₃. Among these metal oxides, a negative electrode active material having a potential not lower than 0.5 V relative to the metal lithium, for example, a titanium-containing metal composite oxide such as lithium titanate is preferably used since the generation of lithium dendrites on the negative electrode even when the battery is rapidly charged can be suppressed, and therefore deterioration of the negative electrode can be suppressed.

Examples of the titanium-containing metal composite oxide include a titanium-based oxide which does not contain lithium when the oxide is synthesized, a lithium-titanium oxide, and a lithium-titanium composite oxide obtained by substituting at least one foreign element selected from the group consisting of Nb, Mo, W, P, V, Sn, C, Ni, and Fe for a part of the constituting elements of the lithium-titanium oxide. Examples of the lithium-titanium oxide include lithium titanate having a spinel structure (e.g., Li₄₊ₓTi₅O₁₂ (where x may be changed within a range of 0≦x≦3 during charge and discharge)), a titanium oxide having a bronze structure (B) or an anatase structure (e.g., LiₓTiO₂ (0≦x≦1), a composition before charging is TiO₂)), and lithium titanate having a ramsdellite structure (e.g., Li_{2+y}Ti₃O₇ (where y may be changed within a range of 0≦y≦3 during charge and discharge)), and a niobium titanium oxide (e.g., LiₓNbₐTiO₇ (0≦x, and more preferably 0≦x≦1, 1≦a≦4)).

Examples of the titanium-based oxide include TiO₂ and a metal composite oxide containing Ti and at least one element selected from the group consisting of P, V, Sn, Cu, Ni, Co, and Fe. It is preferable that TiO₂ is of an anatase type, and has a low crystallinity, which is obtained by a heat treatment at 300 to 500° C. Examples of the metal composite oxide containing Ti and at least one element selected from the group consisting of P, V, Sn, Cu, Ni, Co, and Fe include TiO₂—P₂O₅, TiO₂—V₂O₅, TiO₂—P₂O₅—SnO₂, and TiO₂—P₂O₅-MeO (Me denoting at least one element selected from the group consisting of Cu, Ni, Co, and Fe). The metal composite oxide preferably has a micro structure in which a crystalline phase and an amorphous phase are present together, or an amorphous phase alone is present. The micro structure can markedly improve the cycle performance of the battery. Particularly, the lithium-titanium oxide and the metal composite oxide containing Ti and at least one element selected from the group consisting of P, V, Sn, Cu, Ni, Co, and Fe are preferable.

Examples of the metal sulfide include lithium sulfide (TiS₂), molybdenum sulfide (MOS₂), and iron sulfides (FeS, FeS₂, LiₓFeS₂ (wherein 0<x≦1)). Examples of the metal nitride include a lithium-cobalt nitride (LiₓCo_{y}N (wherein 0<x<4 and 0<y<0.5)).

Lithium titanate having a spinel structure is desirably used as the negative electrode active material.

A carbon material can be used as the conductive agent. Examples of the carbon material include acetylene black, carbon black, coke, carbon fiber, and graphite.

Polytetrafluoro ethylene (PTFE), polyvinylidene fluoride (PVdF), an ethylene-propylene-diene copolymer (EPDM), styrene-butadiene rubber (SBR), and carboxymethyl cellulose (CMC) or the like can be used as the binder.

Various kinds of metal foils can be used as the negative electrode current collector in accordance with the potential of the negative electrode. Examples of the metal foils include an aluminum foil, an aluminum alloy foil, a stainless steel foil, a titanium foil, a copper foil, and a nickel foil. At this time, the metal foil preferably has a thickness of 8 μm or more and 25 μm or less. When the negative electrode potential is nobler than the metal lithium potential by at least 0.3 V by using, for example, a lithium-titanium oxide as the negative electrode active material, an aluminum foil or an aluminum alloy foil is preferably used since the use of the aluminum foil or aluminum alloy foil can suppress the battery weight.

The aluminum foil and the aluminum alloy foil preferably have an average crystal grain diameter of 50 μm or less. Thereby, since the strength of the negative electrode current collector can be drastically increased, the density of the negative electrode can be increased under a high press pressure, which can increase the battery capacity. Since it is possible to prevent the dissolution and corrosion deterioration of the negative electrode current collector over an over-discharge cycle under an environment of a high temperature (40° C. or higher), it is possible to suppress elevation in the impedance of the negative electrode. Furthermore, the high-rate characteristics, the rapid charging characteristics, and the charge-and-discharge cycle characteristics of the battery can be improved. The average crystal grain diameter of the negative electrode current collector is more preferably 30 μm or less, and still more preferably 5 μm or less.

The average crystal grain size can be calculated as follows. The structure of the surface of the current collector is observed with an optical microscope and a crystal grain number n present in a region of 1 mm×1 mm is calculated. An average crystal grain area S is calculated by plugging the number n into the equation: S (μm²)=1×10⁶/n. An average crystal grain size d (μm) is calculated by plugging the obtained value of S into Equation (1) below.

d=2(S/π)^{1/2} (1)

The average crystal grain size of the current collector is intricately influenced by many factors, such as composition of materials, impurities contained in the material, processing conditions, heat treatment histories, and annealing conditions. The average crystal grain size of the current collector can be controlled by adjusting the combination of the above-described various factors during the production process.

The aluminum foil and the aluminum alloy foil preferably have a thickness of 20 μm or less, and more preferably 15 μm or less. The aluminum foil preferably has a purity of 99% or more. The aluminum alloy preferably contains at least one element of magnesium, zinc, and silicon or the like. On the other hand, the content of the transition metals such as iron, copper, nickel, and chromium in the aluminum alloy is preferably 1% or less. When the battery is mounted to a vehicle, an aluminum alloy foil is particularly preferably used.

Concerning the mixing ratio of the active material, the conductive agent, and the binder in the negative electrode, it is preferable that the negative electrode active material is used in an amount of 80 to 95% by weight; the conductive agent is used in an amount of 3 to 20% by weight; and the binder is used in an amount of 1.5 to 7% by weight.

[2] Positive Electrode

A positive electrode can be prepared by coating a positive electrode material paste prepared by dispersing, for example, a positive electrode active material, a conductive agent, and a binder in a suitable solvent on one surface or both surfaces of a positive electrode current collector, and drying the positive electrode material paste. The positive electrode can also be pressed after drying.

Examples of the positive electrode active material include various oxides and sulfides. Examples thereof include manganese dioxide (MnO₂), iron oxide, copper oxide, nickel oxide, a lithium-manganese composite oxide (e.g., LiₓMn₂O₄ or LiₓMnO₂ (wherein 0≦x≦1.2)), a lithium-nickel composite oxide ((e.g., LiₓNiO₂ (wherein 0≦x≦1.2)), a lithium-cobalt composite oxide (e.g., LiₓCoO₂ (wherein 0≦x≦1.2)), a lithium-nickel-cobalt composite oxide ((e.g., LiNi_{1-y}CO_{y}O₂ (wherein 0<y≦1)), a lithium-manganese-cobalt composite oxide ((e.g., LiMn_{y}Co_{1-y}O₂ (wherein 0<y≦1)), a spinel type lithium-manganese-nickel composite oxide (LiₓMn_{2-y}Ni_{y}O₄ (wherein 0≦x≦1.2 and 0<y≦1)), a lithium-phosphorus oxide having an olivine structure (LiₓFePO₄, LiₓFe_{1-y}Mn_{y}PO₄, LiₓMnPO₄, LiₓMn_{1-y}Fe_{y}PO₄, and LiₓCoPO₄ or the like (wherein 0≦x≦1.2 and 0<y≦1)), iron sulfate (Fe₂(SO₄)₃), and vanadium oxide (e.g., V₂O₅).

Examples of the positive electrode active material include a conductive polymer material such as polyaniline or polypyrrole, and organic and inorganic materials such as a disulfide-based polymer material, sulfur (S), and fluorocarbon.

More preferable examples of the positive electrode active material include spinel type manganese-lithium composite oxide having high thermal stability (LiₓMn₂O₄ (wherein 0≦x≦1.1)), olivine type lithium iron phosphate (LiₓFePO₄ (wherein 0≦x≦1)), olivine type lithium manganese phosphate (LiₓMnPO₄ (wherein 0≦x≦1)), and olivine type lithium iron manganese phosphate (LiₓMn_{1-y}Fe_{y}PO₄ (wherein 0≦x≦1 and 0<y≦0.5)).

Alternatively, two or more kinds of the positive electrode active materials can be mixed.

For example, acetylene black, carbon black, synthetic graphite, natural graphite, and a conductive polymer or the like can be used as the conductive agent.

For example, polytetrafluoro ethylene (PTFE), polyvinylidene fluoride (PVdF), denatured PVdF having another substituent substituted therein for at least one of hydrogen and fluorine contained in PVdF, terpolymer of a vinylidene fluoride-hexafluoro propylene copolymer, and a vinylidene fluoride-tetrafluoro ethylene-hexafluoro propylene or the like can be used as the binder.

N-methyl-2-pyrrolidone (NMP) and dimethyl formamide (DMF) or the like are used as the organic solvent for dispersing the binder.

Examples of the positive electrode current collector include an aluminum foil, an aluminum alloy foil, a stainless steel foil, and a titanium foil. Each of these metal foils has a thickness of, for example, 8 to 25 μm.

The positive electrode current collector is preferably formed of an aluminum foil or an aluminum alloy foil. The positive electrode current collector has an average crystal grain diameter of preferably 50 μm or less, more preferably 30 μm or less, and still more preferably 5 μm or less, as in the negative electrode current collector. When the average crystal grain diameter is 50 μm or less, the strength of the aluminum foil or the aluminum alloy foil can be drastically increased, and the density of the positive electrode can be increased under a high press pressure, which can increase the battery capacity.

The average crystal grain size of the current collector is intricately influenced by many factors such as composition of materials, impurities contained in the material, processing conditions, heat treatment histories, and annealing conditions. The average crystal grain size of the current collector can be controlled by adjusting the combination of the above-described various factors during the production process.

The aluminum foil and the aluminum alloy foil have a thickness of preferably 20 μm or less, and more preferably 15 μm or less. The aluminum foil has a purity of 99% or more. The aluminum alloy preferably contains elements such as magnesium, zinc, and silicon. On the other hand, the content of the transition metals such as iron, copper, nickel, and chromium is preferably 1% or less.

Concerning the mixing ratio of the active material, the conductive agent, and the binder in the positive electrode, the positive electrode active material is preferably used in an amount of 80 to 95% by weight; the conductive agent is preferably used in an amount of 3 to 20% by weight; and the binder is preferably used in an amount of 1.5 to 7% by weight.

[3] Separator

For example, a porous separator can be used as the separator.

Examples of the porous separator include a porous film and a synthetic resin unwoven fabric which contain polyethylene, polypropylene, cellulose, or polyvinylidene fluoride (PVdF). Particularly, the porous film made of polyethylene and/or polypropylene is preferable since a shut-down function, in which the pores of the porous film are closed when the battery temperature is elevated so as to decrease markedly the charge-discharge current, can be easily imparted to the porous film, with the result that the safety of the secondary battery can be improved. From the viewpoint of cutting down the cost, the cellulose-based separator is preferably used.

[4] Nonaqueous Electrolyte

Examples of the nonaqueous electrolyte include an organic electrolytic solution prepared by dissolving at least one kind of a lithium salt selected from LiBF₄, LiPF₆, LiAsF₆, LiClO₄, LiCF₃SO₃, LiN(CF₃SO₂)₂, LiN (C₂F₅SO₂)₂, Li(CF₃SO₂)₃C, and LiB[(OCO)₂]₂ or the like in an organic solvent in a concentration of 0.5 to 2 mol/L.

Examples of the organic solvent include cyclic carbonates such as propylene carbonate (PC) and ethylene carbonate (EC); linear carbonates such as diethyl carbonate (DEC), dimethyl carbonate (DMC), and methyl ethyl carbonate (MEC); linear ethers such as dimethoxy ethane (DME) and diethoxy ethane (DEE); cyclic ethers such as tetrahydrofuran (THF) and dioxolane (DOX); and γ-butyrolactone (GBL), acetonitrile (AN), and sulfolane (SL). These organic solvents are preferably used singly or in the form of a mixed solvent.

An ambient temperature molten salt containing lithium ions (ionic liquid) can be used as the nonaqueous electrolyte. When an ionic liquid formed of lithium ions, organic cations and anions, and in a liquid state under temperatures of 100° C. or less, and preferably room temperature or less is selected, a secondary battery which can be operated under a wide temperature range can be obtained.

[5] Case

A stainless steel member which may be used as the case desirably has a thickness of 0.2 mm or less. For example, the stainless steel member can contain a composite film material prepared by stacking a heat-fusible resin film (thermoplastic resin film) forming the innermost layer, a metal foil made of stainless steel, and an organic resin film having a rigidity in this order.

For example, a polyethylene (PE) film, a polypropylene (PP) film, a polypropylene-polyethylene copolymer film, an ionomer film, and an ethylene vinyl acetate (EVA) film or the like can be used as the heat-fusible resin film. For example, a polyethylene terephthalate (PET) film and a nylon film or the like can be used as the organic resin film having rigidity.

The case may include a case body and a lid body. The case body includes a concave part capable of serving as the housing part housing the electrode group and a peripheral part extending outside the concave part. In this case, the case body and the lid body may be an integrated member which is seamless and consecutive.

[6] Electrode Lead

Aluminum, titanium, an alloy thereof, and stainless steel or the like can be used as the electrode lead which may electrically be connected to the positive electrode, that is, a positive electrode lead.

Nickel, copper, and an alloy thereof or the like can be used as the electrode lead which may electrically be connected to the negative electrode, that is, a negative electrode lead. When the negative electrode potential is nobler than the potential of metal lithium by at least 1 V, for example, when lithium titanate is used as the negative electrode active material, aluminum or an aluminum alloy can be used as the material of the negative electrode lead. In this case, each of the positive electrode lead and the negative electrode lead is preferably formed of aluminum or an aluminum alloy since the electrode leads can be made light in weight and the electric resistance of the electrode leads can be suppressed to a low level.

It is preferable that the strengths of the positive electrode lead and the negative electrode lead do not exceed markedly the strength of the positive electrode current collector or the negative electrode current collector connected to the positive electrode lead and the negative electrode lead from the viewpoint of mechanical properties, since stress concentration on the connecting portion between the electrode lead and the current collector can be moderated. When ultrasonic welding, which is one of the preferable methods, is applied as the connecting means for connecting the electrode lead to the current collector, and the positive electrode lead or the negative electrode lead has a small Young's modulus, strong welding can be easily achieved.

For example, pure aluminum (order of JIS 1000) subjected to annealing treatment is preferable as the material of the positive electrode lead or the negative electrode lead.

The positive electrode lead has a thickness of desirably 0.1 to 1 mm, and more preferably 0.2 to 0.5 mm.

The negative electrode lead has a thickness of desirably 0.1 to 1 mm, and more preferably 0.2 to 0.5 mm.

[7] Insulating Member

An additional insulating member which can be included in at least one of the first zone and the second zone of the lead-sandwiching part may be an insulating ring or insulating member made of a thermoplastic resin, for example.

Hereinafter, some examples of the nonaqueous electrolyte battery according to the first embodiment will be described with reference to the drawings.

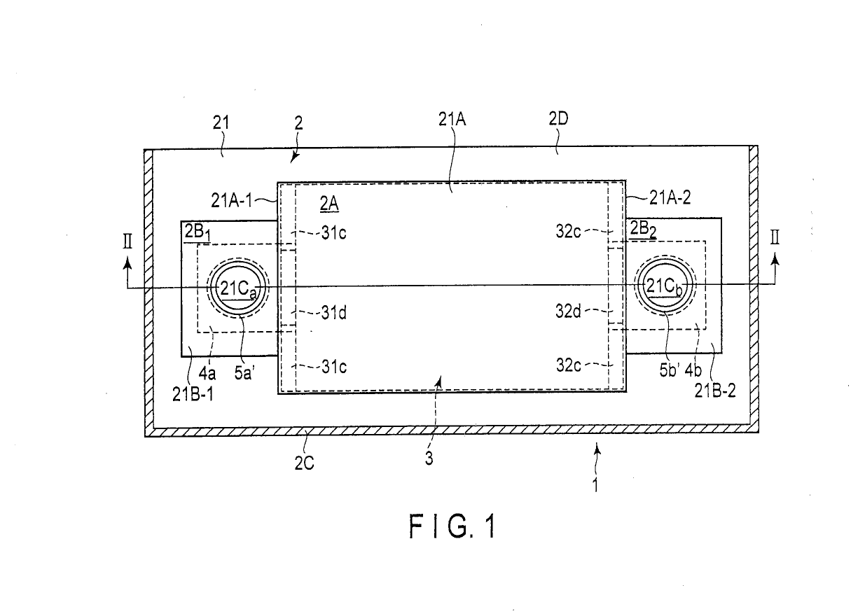

First, a nonaqueous electrolyte battery of a first example will be described with reference to FIGS. 1 to 5.

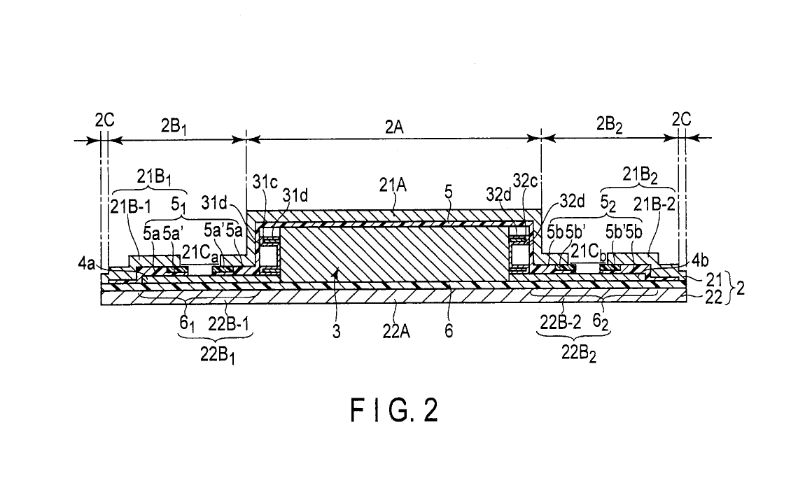

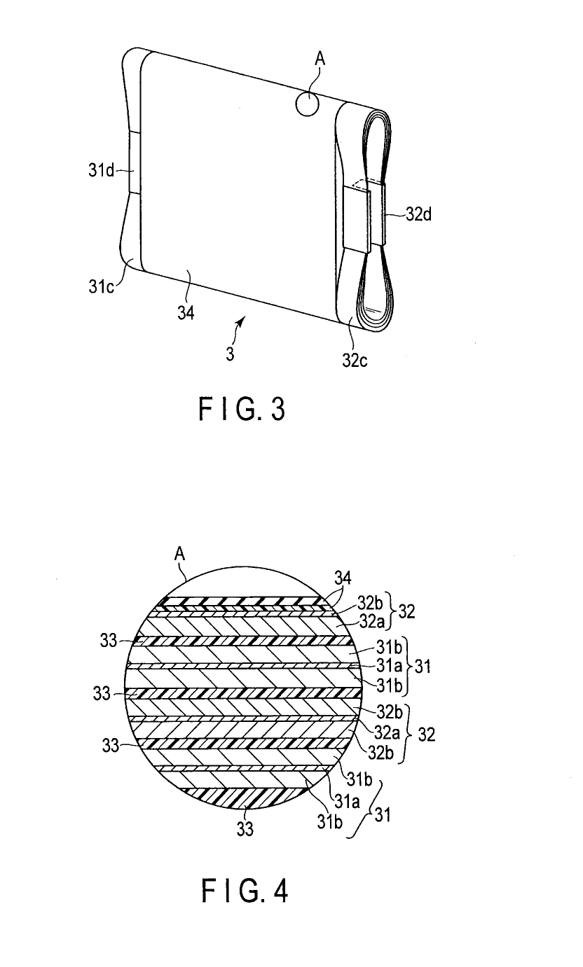

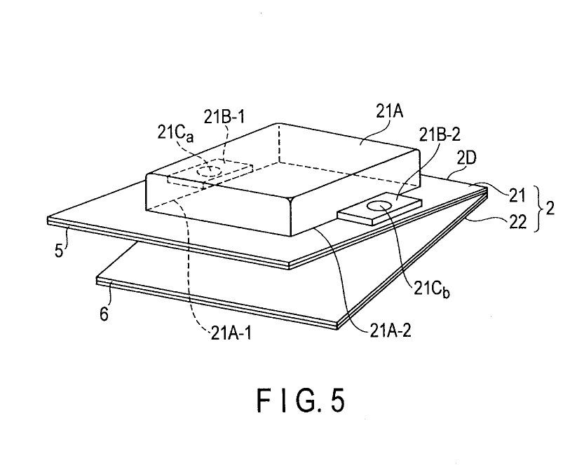

FIG. 1 is a schematic plan transparent view of the nonaqueous electrolyte battery of the first example according to the first embodiment. FIG. 2 is a schematic sectional view taken along line II-II of the nonaqueous electrolyte battery shown in FIG. 1. FIG. 3 is a schematic perspective view of an electrode group included in the nonaqueous electrolyte battery shown in FIG. 1. FIG. 4 is an enlarged sectional view of part A of FIG. 3. FIG. 5 is a schematic development perspective view of a case included in the nonaqueous electrolyte battery of the first example according to the first embodiment.

A nonaqueous electrolyte battery 1 shown in FIGS. 1 to 5 includes an electrode group 3 shown in detail in FIGS. 3 and 4.

The electrode group 3 has a wound-type structure having a flat shape as shown in FIG. 3. FIG. 4 is a schematic sectional view including the outermost periphery of the electrode group 3. As shown in FIG. 4, a negative electrode 32 is positioned at the outermost periphery of the electrode group 3. A separator 33, a positive electrode 31, a separator 33, a negative electrode 32, a separator 33, a positive electrode 31, and a separator 33 are positioned on the inner circumference side of the negative electrode 32.

As shown in FIG. 4, the positive electrode 31 includes a positive electrode current collector 31a and a positive electrode material layer 31b formed on both surfaces of the positive electrode current collector 31a. The positive electrode current collector 31a includes a positive-electrode-material-layer-non-supporting part 31c on which the positive electrode material layer 31b is not formed, as shown in FIG. 3. Similarly, the negative electrode 32 includes a negative electrode current collector 32a and a negative electrode material layer 32b formed on both surfaces of the negative electrode current collector 32a. In a portion of the negative electrode 32 positioned at the outermost periphery, the negative electrode material layer 32b is formed only on one surface of the negative electrode current collector 32a. The negative electrode current collector 32a includes a negative-electrode-material-layer-non-supporting part 32c on which the negative electrode material layer 32b is not formed, as shown in FIG. 3. As shown in FIG. 3, the positive-electrode-material-layer-non-supporting part 31c and the negative-electrode-material-layer-non-supporting part 32c protrude in mutually opposite directions from the electrode group 3.

The electrode group 3 can be obtained by stacking the band-like positive electrode 31 and the band-like negative electrode 32 with the separator 33 sandwiched therebetween, to form an electrode group assembly, subsequently spirally winding the electrode group assembly, and thereafter pressing the assembly into a flat shape.

As shown in FIG. 3, the positive-electrode-material-layer-non-supporting part 31c of the electrode group 3 is electrically connected to a current collecting tab 31d of the positive electrode 31 in a bundled state. The positive-electrode-material-layer-non-supporting part 31c can be electrically connected to the current collecting tab 31d of the positive electrode 31 by, for example, subjecting the positive-electrode-material-layer-non-supporting part 31c and the current collecting tab 31d of the positive electrode 31 holding a part of the positive-electrode-material-layer-non-supporting part 31c to welding such as ultrasonic welding. Similarly, the negative-electrode-material-layer-non-supporting part 32c of the electrode group 3 is electrically connected to a current collecting tab 32d of the negative electrode 32 in a bundled state. The negative-electrode-material-layer-non-supporting part 32c can be electrically connected to the current collecting tab 32d of the negative electrode 32 by, for example, subjecting the negative-electrode-material-layer-non-supporting part 32c and the current collecting tab 32d of the negative electrode 32 holding a part of the negative-electrode-material-layer-non-supporting part 32c to welding such as ultrasonic welding. Herein, the current collecting tab 31d of the positive electrode 31 or the current collecting tab 32d of the negative electrode 32 may be produced integrally with the positive electrode current collector 31a or the negative electrode current collector 32a.

As shown in FIG. 3, in the electrode group 3, an insulating tape 34 is wound around a portion excluding the positive-electrode-material-layer-non-supporting part 31c, the current collecting tab 31d of the positive electrode 31, the negative-electrode-material-layer-non-supporting part 32c, and the current collecting tab 32d of the negative electrode 32.

The nonaqueous electrolyte battery 1 shown in FIGS. 1 to 5 further includes two electrode leads, that is, a positive electrode lead 4a and a negative electrode lead 4b.

As shown in FIGS. 1 and 2, the positive electrode lead 4a has a strip shape. The positive electrode lead 4a has one end electrically connected to the current collecting tab 31d of the positive electrode 31. Similarly, the negative electrode lead 4b has a strip shape. The negative electrode lead 4b has one end electrically connected to the current collecting tab 32d of the negative electrode 32. Herein, the positive electrode lead 4a or the negative electrode lead 4b may be produced integrally with the current collecting tab 31d of the positive electrode 31 or the current collecting tab 32d of the negative electrode 32, respectively.

Thus, the positive electrode lead 4a and the negative electrode lead 4b are electrically connected to the electrode group 3, and extend in mutually opposite directions from the electrode group 3.

The nonaqueous electrolyte battery 1 shown in FIGS. 1 to 5 further includes a case 2. The schematic development perspective view of the case 2 is shown in FIG. 5.

The case 2 is made of stainless steel. The case 2 includes a case body 21 having a rectangular plane shape as shown in FIG. 1 and a plate-shaped lid 22 having a principal surface opposed to the case body 21 as shown in FIGS. 2 and 5.

As shown in FIGS. 1 and 2, three peripheral portions 2C of the case body 21 are seam-welded to the lid 22. Thereby, the case 2 includes three sealed parts 2C in which the case body 21 and the lid 22 are welded in three peripheral portions of the case 2 by seam welding. As shown in FIGS. 1 and 5, the case body 21 is seamlessly disposed in communication with the lid 22 in the remaining peripheral portion 2D. That is, the case 2 of the present embodiment is constituted by integrally forming the case body 21 and the lid 22, and folding the case body 21 and the lid 22 in the folded part 2D.

As shown in FIGS. 1 and 2, in the case body 21, a concave part 21A having a rectangular plane shape is formed in a part of a portion surrounded by the three sealed parts 2C and the folded part 2D. The concave part 21A spreads in a direction away from the lid 22. As shown in FIG. 2, the concave part 21A of the case body 21 and a portion 22A of the lid 22 opposed to the concave part 21A constitute a housing part 2A of the case 2.

The case body 21 further includes two concave parts 21B-1 and 21B-2 respectively extending outside the concave part 21A from a part of an edge 21A-1 and a part of an edge 21A-2 of the concave part 21A opposed to each other, as shown in FIGS. 1, 2, and 5. As shown in FIG. 2, the two concave parts 21B-1 and 21B-2 spread in a direction away from the lid 22 as in the concave part 21A, and have a rectangular plane shape on the same plane.

FIGS. 2 and 5 exaggeratingly show the depth of the concave part 21B-1 and the depth of the concave part 21B-2 in order to emphasize the existence of the concave part 21B-1 and the concave part 21B-2. However, as will be described in detail below, the positive electrode lead 4a and the negative electrode lead 4b are respectively sandwiched between the concave part 21B-1 and a part of the lid 22, and between the concave part 21B-2 and a part of the lid 22. Therefore, the depths of the concave part 21B-1 and the concave part 21B-2 are sufficient as long as the depths correspond to the thicknesses of the positive electrode lead 4a and the negative electrode lead 4b. That is, in fact, the concave part 21B-1 and the concave part 21B-2 formed in the case body 21 may have a depth smaller than that shown in FIGS. 2 and 5. This also similarly applies in the other drawings of the present application.

The case 2 which includes the case body 21 including the concave part 21A, the concave part 21B-1, and the concave part 21B-2, and the lid 22 as shown in FIG. 5 can be obtained by subjecting a stainless steel plate to forging processing such as deep drawing processing or press processing, to form the concave parts 21A, 21B-1, and 21B-2 as shown in FIG. 5, and thereafter bending a portion which is not subjected to forging, for example.

As shown in FIGS. 1, 2, and 5, the bottom parts of the two concave parts 21B-1 and 21B-2 of the case body 21 respectively have opening parts 21Cₐ and 21C_{b} passing through the bottom parts. The opening parts 21Cₐ and 21C_{b} have a circular surface shape, as shown in FIGS. 1 and 5.

As shown in FIGS. 1 and 2, an insulating ring 5a′ is disposed in the peripheral part of the opening part 21Cₐ in the bottom face of the concave part 21B-1. Similarly, an insulating ring 5b′ is disposed in the peripheral part of the opening part 21C_{b} in the bottom part of the concave part 21B-2.

The insulating rings 5a′ and 5b′ are thermoplastic insulating rings. The inner diameters of the insulating rings 5a′ and 5b′ are respectively smaller than those of the opening parts 21Cₐ and 21C_{b}. Therefore, as shown in FIGS. 1 and 2, a part of the insulating ring 5a′ and a part of the insulating ring 5b′ are exposed through the opening parts 21Cₐ and 21C_{b}.

As shown in FIG. 2, the entire surface of the case body 21 opposed to the lid 22 and excluding a portion on which the insulating rings 5a′ and 5b′ are disposed is covered with a thermoplastic resin layer 5. The surfaces of the insulating rings 5a′ and 5b′ opposed to the lid 22 are also covered with the thermoplastic resin layer 5. Thus, the surface of the concave part 21B-1 of the case body 21 opposed to the lid 22 is covered with the thermoplastic resin layer 5a and the insulating ring 5a′. Similarly, the surface of the concave part 21B-2 of the case body 21 opposed to the lid 22 is covered with the thermoplastic resin layer 5b and the insulating ring 5b′.

On the other hand, the entire surface of the lid 22 opposed to the case body 21 is covered with a thermoplastic resin layer 6 as shown in FIG. 2. As shown in FIG. 2, a part of the thermoplastic resin layer 6 is in contact with the thermoplastic resin layer 5. The case body 21 is heat-sealed to the lid 22 in a state where the thermoplastic resin layer 5 and the thermoplastic resin layer 6 being in contact with the thermoplastic resin layer 5 are sandwiched between the case body 21 and the lid 22.

As shown in FIG. 2, the thermoplastic resin layer 5 includes a portion 5a covering the concave part 21B-1. The portion 5a of the thermoplastic resin layer 5 and the insulating ring 5a′ constitute a first insulating member 5₁. The concave part 21B-1 of the case body 21, the first insulating member 5₁, and the opening part 21Cₐ constitute a first zone 21B₁ of the case body 21.

Similarly, the thermoplastic resin layer 5 includes a portion 5b covering the concave part 21B-2. The portion 5b of the thermoplastic resin layer 5 and the insulating ring 5b′ constitute a first insulating member 5₂. The concave part 21B-2 of the case body 21, the first insulating member 5₂, and the opening part 21C_{b} constitute a first zone 21B₂ of the case body 21.

On the other hand, the thermoplastic resin layer 6 includes a portion 6₁ opposed to the first zone 21B₁ of the case body 21 as a second insulating member. The portion 6₁ of the thermoplastic resin layer 6 and a portion 22B-1 of the lid 22 opposed to the first zone 21B₁ of the case body 21 constitute a second zone 22B₁ of the lid 22. The thermoplastic resin layer 6 includes a portion 6₂ opposed to the first zone 21B₂ of the case body 21 as the second insulating member. The portion 6₂ of the thermoplastic resin layer 6 and a portion 22B-2 of the lid 22 opposed to the first zone 21B₂ of the case body 21 constitute a second zone 22B₂ of the lid 22.

Both the first zone 21B₁ of the case body 21 and the second zone 22B₁ of the lid 22 described above constitute a lead-sandwiching part 2B₁ of the case 2 shown in FIGS. 1 and 2. Similarly, both the first zone 21B₂ of the case body 21 and the second zone 22B₂ of the lid 22 constitute a lead-sandwiching part 2B₂ of the case 2 shown in FIGS. 1 and 2. As shown in FIGS. 1 and 2, in the case 2, the lead-sandwiching part 2B₁ and the lead-sandwiching part 2B₂ are each positioned between the housing part 2A and the sealed part 2C.

As shown in FIGS. 1 and 2, the electrode group 3 previously described is housed in the housing part 2A of the case body 21 described above. A nonaqueous electrolyte (not shown) is housed in the housing part 2A of the case body 21. The nonaqueous electrolyte is retained by the electrode group 3.

In the lead-sandwiching part 2B₁ of the case 2, as shown in FIG. 2, the first zone 21B₁ and the second zone 22B₁ sandwich the positive electrode lead 4a therebetween. Similarly, in the lead-sandwiching part 2B₂ of the case 2, as shown in FIG. 2, the first zone 21B₂ and the second zone 22B₂ sandwich the negative electrode lead 4b therebetween.

As described in detail in FIG. 2, the positive electrode lead 4a is in contact with the portion 5a of the thermoplastic resin layer 5 constituting the first zone 21B₁ of the lead-sandwiching part 2B₁. The positive electrode lead 4a is also in contact with the portion 6₁ of the thermoplastic resin layer 6 constituting the second zone 22B₁ of the lead-sandwiching part 2B₁. Similarly, the negative electrode lead 4b is in contact with the portion 5b of the thermoplastic resin layer 5 constituting the first zone 21B₂ of the lead-sandwiching part 2B₂. The negative electrode lead 4b is also in contact with the portion 6₂ of the thermoplastic resin layer 6 constituting the second zone 22B₂ of the lead-sandwiching part 2B₂.

Herein, as shown in FIGS. 1 and 2, a part of the positive electrode lead 4a is exposed through the opening part 21Cₐ formed in the first zone 21B₁ of the lead-sandwiching part 2B₁. Similarly, a part of the negative electrode lead 4b is exposed through the opening part 21C_{b} formed in the first zone 21B₂ of the lead-sandwiching part 2B₂.

The first zone 21B₁ of the case body 21 is heat-sealed to the positive electrode lead 4a by the portion 5a of the thermoplastic resin layer 5 and the insulating ring 5a′ which constitute the first zone 21B₁. Thereby, the positive electrode lead 4a is heat-sealed to the periphery of the opening part 21Cₐ of the first zone 21B₁ by the portion 5a of the thermoplastic resin layer 5 and the insulating ring 5a′. Furthermore, the second zone 22B₁ of the lid 22 is heat-sealed to the positive electrode lead 4a by the portion 6₁ of the thermoplastic resin layer 6 constituting the second zone 22B₁.

Similarly, the first zone 21B₂ of the case body 21 is heat-sealed to the negative electrode lead 4b by the portion 5b of the thermoplastic resin layer 5 and the insulating ring 5b′ which constitute the first zone 21B₂. Thereby, the negative electrode lead 4b is heat-sealed to the periphery of the opening part 21C_{b} of the first zone 21B₂ by the thermoplastic resin layer 5b and the insulating ring 5b′. Furthermore, the second zone 22B₂ of the lid 22 is heat-sealed to the negative electrode lead 4b by the portion 6₂ of the thermoplastic resin layer 6 constituting the second zone 22B₂.

In addition, in the nonaqueous electrolyte battery 1 of the first example shown in FIGS. 1 to 5 having the constitution described above, the positive electrode lead 4a is electrically insulated from the case 2 by the thermoplastic resin layer 5a, the insulating ring 5a′, and the portion 6₁ of the thermoplastic resin layer 6. Similarly, the negative electrode lead 4b is electrically insulated from the case 2 by the thermoplastic resin layer 5b, the insulating ring 5b′, and the portion 6₂ of the thermoplastic resin layer 6.

In the nonaqueous electrolyte battery 1 of the first example shown in FIGS. 1 to 5, as described above, the first zone 21B₁ and the second zone 22B₁ of the lead-sandwiching part 2B₁ sandwich the positive electrode lead 4a therebetween. The first zone 21B₂ and the second zone 22B₂ of the lead-sandwiching part 2B₂ sandwich the negative electrode lead 4b therebetween. Therefore, there is no space which permits the penetration of moisture between the first zone 21B₁ and the positive electrode lead 4a, between the second zone 22B₁ and the positive electrode lead 4a, between the first zone 21B₂ and the negative electrode lead 4b, and between the second zone 22B₂ and the negative electrode lead 4b. Therefore, even if moisture contained in external air infiltrates into the lead-sandwiching parts 2B₁ and 2B₂ through the opening parts 21Cₐ and 21C_{b}, the positive electrode lead 4a and the lead-sandwiching part 2B₁ sandwiching the positive electrode lead 4a between the first zone 21B₁ and the second zone 22B₁, and the negative electrode lead 4b and the lead-sandwiching part 2B₂ sandwiching the negative electrode lead 4b between the first zone 21B₂ and the second zone 22B₂ can prevent moisture penetration through portions therebetween.

Also, as described above, in the nonaqueous electrolyte battery 1 of the first example, the opening parts 2Cₐ and 2C_{b} are respectively formed in the first zones 21B₁ and 21B₂ of the lead-sandwiching parts 2B₁ and 2B₂. The peripheries of the opening parts 21Cₐ and 21C_{b} are respectively heat-sealed to the positive electrode lead 4a and the negative electrode lead 4b by the thermoplastic resin layer 5a and the insulating ring 5a′ or the thermoplastic resin layer 5b and the insulating ring 5b′. Since the heat seal has an excellent sealing property, the heat seal can prevent the moisture from infiltrating into the lead-sandwiching parts 2B₁ and 2B₂. This means that moisture can be further prevented from contacting the electrode group 3 housed in the housing part 2A of the case 2. The heat seal having an excellent sealing property can also further prevent the leakage of the nonaqueous electrolyte housed in the housing part 2A of the case 2 to the exterior of the nonaqueous electrolyte battery 1.

Furthermore, the three sealed parts 2C of the case 2 subjected to seam welding and the folded part 2D can further prevent the infiltration of the moisture into the case 2.

Thus, since the nonaqueous electrolyte battery 1 of the first example shown in FIGS. 1 to 5 can prevent moisture contact occurring in the electrode group 3, the nonaqueous electrolyte battery 1 can prevent deterioration of the electrode group 3, for example, expansion of the electrode group 3 over a long period. As a result, the nonaqueous electrolyte battery of the first example shown in FIGS. 1 to 5 can exhibit a long useful life.

Furthermore, in the nonaqueous electrolyte battery 1 of the first example shown in FIGS. 1 to 5, a part of each of the positive electrode lead 4a and the negative electrode lead 4b electrically connected to the electrode group 3 is exposed through each of the opening parts 21Cₐ and 21C_{b} formed in the first zones 21B₁ and 21B₂ of the lead-sandwiching parts 2B₁ and 2B₂. Therefore, the nonaqueous electrolyte battery 1 of the present Example can easily and certainly obtain electrical connection between the nonaqueous electrolyte battery 1 and an electronic device and/or other battery through the exposed portion.

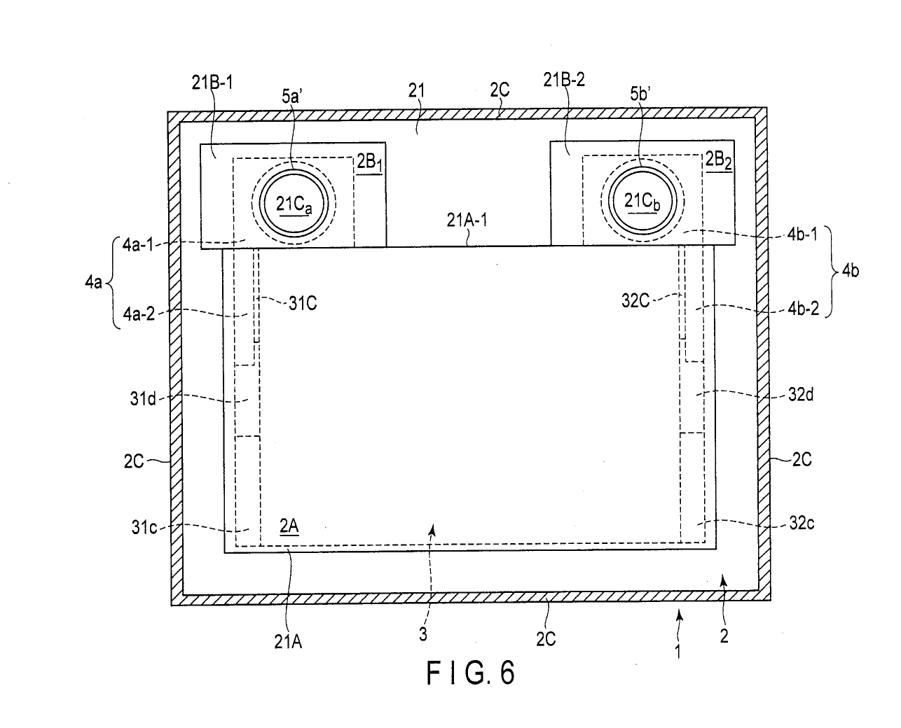

Next, a nonaqueous electrolyte battery of a second example will be described with reference to FIG. 6.

FIG. 6 is a schematic plan transparent view of the nonaqueous electrolyte battery of the second example according to the first embodiment.

A nonaqueous electrolyte battery 1 of the second example shown in FIG. 6 is the same as the nonaqueous electrolyte battery of the first example except for the following points (1) to (3).

(1) A case 2 includes four sealed parts 2C formed in four peripheral portions of the case 2. Therefore, the case 2 does not include a folded part.

(2) Two concave parts 21B-1 and 21B-2 of a case body 21 extend in the same direction to the outside of a concave part 21A from a part of an edge side 21A-1 of the concave part 21A of the case body 21. Since the case 2 includes the case body 21 in which the two concave parts 21B-1 and 21B-2 are formed, the case 2 includes two lead-sandwiching parts 2B₁ and 2B₂ spreading in the same direction from the edge part of a housing part 2A.

(3) A positive electrode lead 4a and a negative electrode lead 4b do not have a strip shape.

The positive electrode lead 4a includes a housing part 4a-1 having a rectangular plane shape, and a band-like connecting part 4a-2 including a vertex of the housing part 4a-1 and extending from a long side. Thereby, the positive electrode lead 4a has a flag-shaped plane shape, as shown in FIG. 6. The housing part 4a-1 of the positive electrode lead 4a is housed in the concave part 21B-1 of the case body 21.

The lead-sandwiching part 2B₁ of the case 2 holds the housing part 4a-1 of the positive electrode lead 4a. In the lead-sandwiching part 2B₁, a part of the housing part 4a-1 of the positive electrode lead 4a is exposed through an opening part 21Cₐ. The housing part 4a-1 of the positive electrode lead 4a is heat-sealed to the periphery of the opening part 21Cₐ by a thermoplastic resin layer which is not shown and an insulating ring 5a′, as in the positive electrode lead in the nonaqueous electrolyte battery of the first example.

In the connecting part 4a-2, a portion including a peripheral portion of the connecting part 4a-2 overlaps a current collecting tab 31d of the positive electrode 31, and is electrically connected thereto.

Similarly, a negative electrode lead 4c includes a housing part 4b-1 having a rectangular plane shape, and a band-like connecting part 4b-2 including a vertex of the housing part 4b-1 and extending from a long side. Thereby, the negative electrode lead 4b has a flag-shaped plane shape, as shown in FIG. 6. The housing part 4b-1 of the negative electrode lead 4b is housed in the concave part 21B-2 of the case body 21.

The lead-sandwiching part 2B₂ of the case 2 holds the housing part 4b-1 of the negative electrode lead 4b. In the lead-sandwiching part 2B₂, a part of the housing part 4b-1 of the negative electrode lead 4b is exposed through an opening part 21C_{b}. The housing part 4b-1 of the negative electrode lead 4b is heat-sealed to the periphery of the opening part 21C_{b} by a thermoplastic resin layer which is not shown and an insulating ring 5b′ as in the negative electrode lead in the nonaqueous electrolyte battery of the first example.

In the connecting part 4b-2, a portion including a peripheral portion of the connecting part 4b-2 overlaps a current collecting tab 32d of the negative electrode 32, and is electrically connected thereto.

As described above, in the nonaqueous electrolyte battery 1 of the second example shown in FIG. 6, the lead-sandwiching part 2B₁ holds the housing part 4a-1 of the positive electrode lead 4a. The lead-sandwiching part 2B₂ holds the housing part 4b-1 of the negative electrode lead 4b. Therefore, there is no space which permits the penetration of moisture between the lead-sandwiching part 2B₁ and the housing part 4a-1 of the positive electrode lead 4a, and between the lead-sandwiching part 2B₂ and the housing part 4b-1 of the negative electrode lead 4b. Therefore, even if moisture contained in external air infiltrates into the lead-sandwiching parts 2B₁ and 2B₂ through the opening parts 21Cₐ and 21C_{b}, the housing part 4a-1 of the positive electrode lead and the lead-sandwiching part 2B₁ holding the housing part 4a-1, and the housing part 4b-1 of the negative electrode lead, and the lead-sandwiching part 2B₂ holding the housing part 4b-1 can prevent moisture penetration through portions therebetween.

As described above, in the nonaqueous electrolyte battery 1 of the second example, the opening part 21Cₐ is formed in the lead-sandwiching part 2B₁, and the opening part 21C_{b} is formed in the lead-sandwiching part 2B₂. The periphery of the opening part 21Cₐ is heat-sealed to the housing part 4a-1 of the positive electrode lead 4a by the thermoplastic resin layer (not shown) and the insulating ring 5a′, and the periphery of the opening part 21C_{b} is heat-sealed to the housing part 4b-1 of the negative electrode lead 4b by the thermoplastic resin layer (not shown) and the insulating ring 5b′. Since the heat seals have an excellent sealing property, the heat seals can prevent the moisture from infiltrating into the lead-sandwiching parts 2B₁ and 2B₂. This means that moisture contact of the electrode group 3 housed in the housing part 2A of the case 2 can be further prevented. The heat seal having an excellent sealing property can also further prevent the leakage of the nonaqueous electrolyte housed in the housing part 2A of the case 2 to the exterior of the nonaqueous electrolyte battery 1.

Furthermore, the four sealed parts 2C of the case 2 subjected to seam welding can further prevent the infiltration of the moisture into the case 2.

Thus, since the nonaqueous electrolyte battery 1 of the second example shown in FIG. 6 can prevent moisture contact occurring in the electrode group 3, the nonaqueous electrolyte battery 1 can prevent deterioration of the electrode group 3, for example, expansion of the electrode group 3 over a long period. As a result, the nonaqueous electrolyte battery of the second example shown in FIG. 6 can exhibit a long useful life.

Furthermore, in the nonaqueous electrolyte battery 1 of the second example shown in FIG. 6, a part of the housing part 4a-1 of the positive electrode lead 4a electrically connected to the electrode group 3 is exposed through the opening part 21Cₐ formed in the lead-sandwiching part 2B₁. Similarly, a part of the housing part 4b-1 of the negative electrode lead 4b electrically connected to the electrode group 3 is exposed through the opening part 21C_{b} formed in the lead-sandwiching part 2B₂. Therefore, the nonaqueous electrolyte battery 1 of the present Example can easily and certainly obtain electrical connection between the nonaqueous electrolyte battery 1 and an electronic device and/or other battery through the exposed portion.

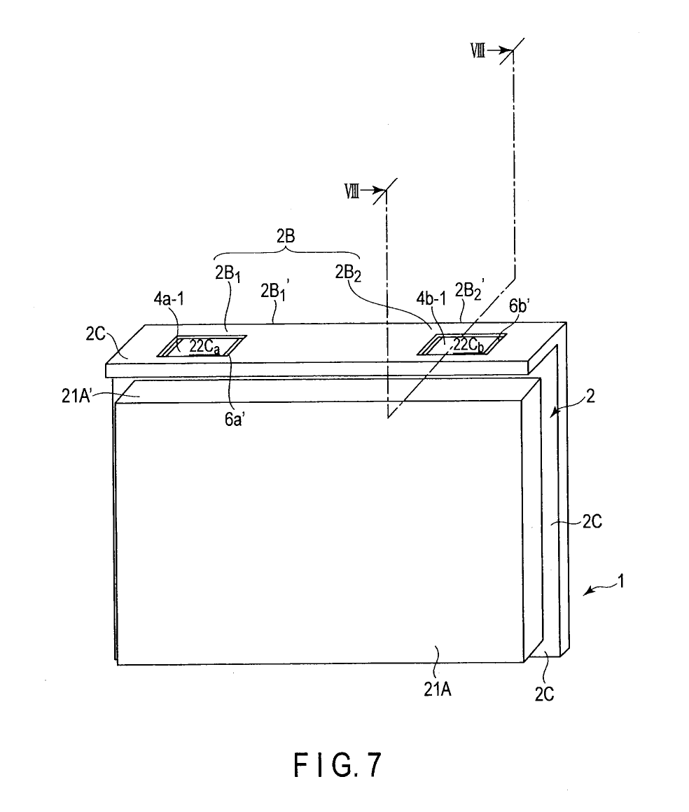

Next, a nonaqueous electrolyte battery of a third example will be described with reference to FIGS. 7 to 9.

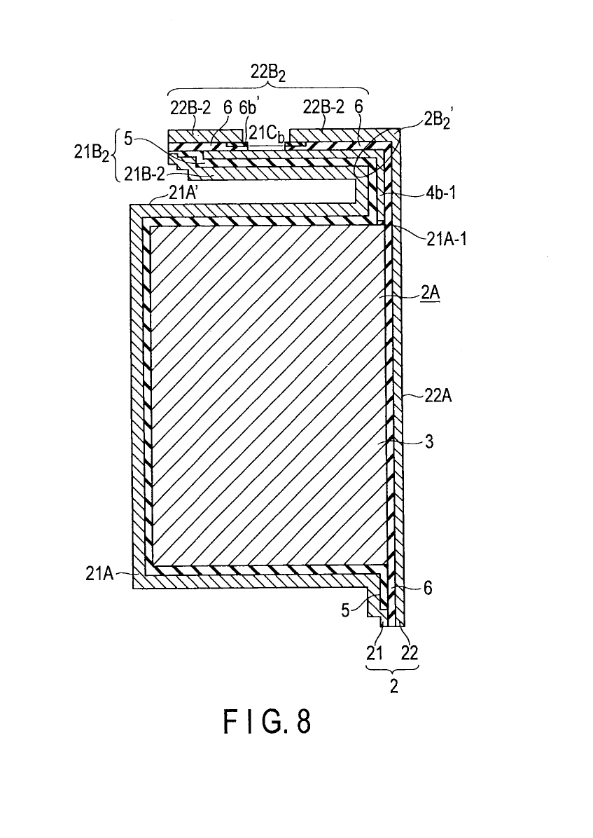

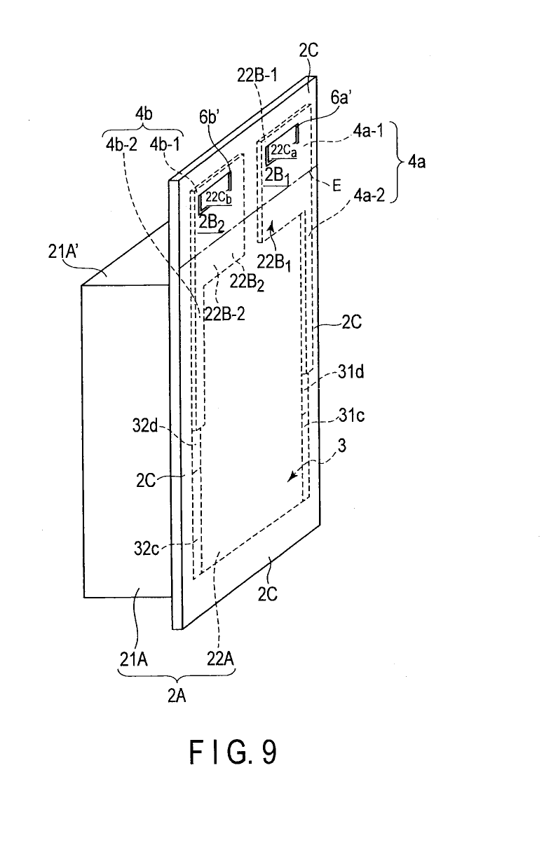

FIG. 7 is a schematic perspective view of the nonaqueous electrolyte battery of the third example according to the first embodiment. FIG. 8 is a schematic sectional view taken along line VIII-VIII of the nonaqueous electrolyte battery shown in FIG. 7. FIG. 9 is a schematic perspective view before a bent part is formed in a lead-sandwiching part of the nonaqueous electrolyte battery shown in FIGS. 7 and 8.

A nonaqueous electrolyte battery 1 shown in FIGS. 7 to 9 includes an electrode group 3, a positive electrode lead 4a, and a negative electrode lead 4b. The electrode group 3, the positive electrode lead 4a, and the negative electrode lead 4b are the same as those included in the nonaqueous electrolyte battery 1 of the second example described with reference to FIG. 6. As shown in FIG. 9, in a connecting part 4a-2 of the positive electrode lead 4a, a portion including an end part of the connecting part 4a-2 is electrically connected to a current collecting tab 31d of the positive electrode 31 of the electrode group 3. In a connecting part 4b-2 of the negative electrode lead 4b, a portion including an end part of the connecting part 4b-2 is electrically connected to a current collecting tab 32d of the negative electrode 32 of the electrode group 3. That is, the connection of the electrode group 3, the positive electrode lead 4a, and the negative electrode lead 4b in the nonaqueous electrolyte battery 1 shown in FIGS. 7 to 9 is the same as that in the nonaqueous electrolyte battery 1 of the second example described with reference to FIG. 6.

The nonaqueous electrolyte battery 1 shown in FIGS. 7 to 9 further includes a case 2.

The case 2 included in the nonaqueous electrolyte battery 1 shown in FIGS. 7 to 9 is the same as that included in the nonaqueous electrolyte battery 1 of the second example described with reference to FIG. 6 except for the following points.

(A) An opening part is not formed in a case body 21. Instead, in the nonaqueous electrolyte battery 1 shown in FIGS. 7 to 9, opening parts 22Cₐ and 22C_{b} having a rectangular plane shape are formed in portions 22B-1 and 22B-2 of a lid 22 having surfaces opposed to two first zones 21B₂ (one of the first zones is not shown) of the case body 21.

In a lead-sandwiching part 2B₁ of the nonaqueous electrolyte battery 1 shown in FIGS. 7 to 9, a housing part 4a-1 of the positive electrode lead 4a is sandwiched between the first zone (not shown) of the case body 21, and a second zone 22B₁ of the lid 22, and a part of the housing part 4a-1 of the positive electrode lead 4a is exposed through the opening part 22Cₐ. Similarly, in a lead-sandwiching part 2B₂ of the nonaqueous electrolyte battery 1 shown in FIGS. 7 to 9, a housing part 4b-1 of a negative electrode lead 4b is sandwiched by the first zone 21B₂ of the case body 21, and a second zone 22B₂ of the lid 22, and a part of the housing part 4b-1 of the negative electrode lead 4b is exposed through the opening part 22C_{b}.

(B) The nonaqueous electrolyte battery 1 of the third example does not include an insulating ring included in the nonaqueous electrolyte battery 1 of the second example described with reference to FIG. 6. Instead, in the nonaqueous electrolyte battery 1 of the third example shown in FIGS. 7 to 9, insulating members 6a′ and 6b′ are provided on portions opposed to the case body 21, in the peripheral parts of the two opening parts 22Cₐ and 22C_{b} formed in the two portions 22B-1 and 22B-2 of the lid 22.

The insulating members 6a′ and 6b′ are thermoplastic insulating members having an opening. The openings of the insulating members 6a′ and 6b′ have areas smaller than those of the opening parts 22Cₐ and 22C_{b}. Therefore, as shown in FIGS. 7 and 9, a part of the insulating member 6a′ and a part of the insulating member 6b′ are respectively exposed through the opening parts 22Cₐ and 22C_{b}.

The surfaces of the two insulating members 6a′ and 6b′ opposed to the case body 21 are covered with a thermoplastic resin layer 6.

In the constitution, the housing part 4a-1 of the positive electrode lead 4a is heat-sealed to the peripheral part of the opening part 22Cₐ formed in the portion 22B-1 of the lid 22 by the thermoplastic resin layer 6 and the insulating member 6a′. Similarly, the housing part 4b-1 of the negative electrode lead 4b is heat-sealed to the peripheral part of the opening part 22C_{b} formed in the portion 22B-2 of the lid 22 by the thermoplastic resin layer 6 and the insulating member 6b′.

(C) The lead-sandwiching parts 2B₁ and 2B₂ of the case 2 respectively include bent parts 2B₁′ and 2B₂′.

In detail, in the case 2, a portion E represented by a chain dotted line in FIG. 9 is ridge-folded, and thereby, as shown in FIG. 7, a part of each of the two first zones 21B₂ (one of the first zones is not shown) of the case body 21 is opposed to a side surface 21A′ of a concave part 21A of the case body. Thus, the case 2 is bent, and thereby the lead-sandwiching part 2B₁ includes the bent part 2B₁′, and the lead-sandwiching part 2B₂ includes the bent part 2B₂′.

As described above, in the nonaqueous electrolyte battery 1 of the third example shown in FIGS. 7 to 9, the first zone (not shown) and second zone 22B₁ of the lead-sandwiching part 2B₁ sandwich the housing part 4a-1 of the positive electrode lead 4a therebetween. The first zone 21B₂ and the second zone 22B₂ of the lead-sandwiching part 2B₂ sandwich the housing part 4b-1 of the negative electrode lead 4b therebetween. Therefore, there is no space which permits the penetration of moisture between the first zone 21B₁ and the positive electrode lead 4a, between the second zone 22B₁ and the positive electrode lead 4a, between the first zone 21B₂ and the negative electrode lead 4b, and between the second zone 22B₂ and the negative electrode lead 4b. Therefore, even if moisture contained in external air infiltrates into the lead-sandwiching part 2B₁ through the opening part 22Cₐ, or even if moisture contained in external air infiltrates into the lead-sandwiching part 2B₂ through the opening part 22C_{b}, the housing part 4a-1 of the positive electrode lead 4a and the lead-sandwiching part 2B₁ holding the housing part 4a-1, and the housing part 4b-1 of the negative electrode lead 4b and the lead-sandwiching part 2B₂ holding the housing part 4b-1 can prevent moisture penetration through portions therebetween.

As described above, in the nonaqueous electrolyte battery 1 of the third example, the opening part 22Cₐ is formed in the second zone 22B₁ of the lead-sandwiching part 2B₁, and the opening part 22C_{b} is formed in the second zone 22B₂ of the lead-sandwiching part 2B₂. The periphery of the opening part 22Cₐ is heat-sealed to the housing part 4a-1 of the positive electrode lead 4a by the thermoplastic resin layer 6 and the insulating member 6a′, and the periphery of the opening part 22C_{b} is heat-sealed to the housing part 4b-1 of the negative electrode lead 4b by the thermoplastic resin layer 6 and the insulating member 6b′. Since these heat seals have an excellent sealing property, the heat seals can prevent the moisture from infiltrating into the lead-sandwiching parts 2B₁ and 2B₂. This means that moisture contact in the electrode group 3 housed in the housing part 2A of the case 2 can be further prevented. The heat seal having an excellent sealing property can also further prevent the leakage of the nonaqueous electrolyte housed in the housing part 2A of the case 2 to the exterior of the nonaqueous electrolyte battery 1.

Furthermore, the four sealed parts 2C of the case 2 subjected to seam welding can further prevent the infiltration of moisture into the case 2.

Thus, since the nonaqueous electrolyte battery 1 of the third example shown in FIGS. 7 to 9 can prevent moisture contact occurring in the electrode group 3, the nonaqueous electrolyte battery 1 can prevent the deterioration of the electrode group 3, for example, expansion of the electrode group 3 over a long period. As a result, the nonaqueous electrolyte battery of the second example shown in FIG. 6 can exhibit a long useful life.

Furthermore, the four sealed parts 2C formed in the peripheral portion of the case 2 can further prevent infiltration of moisture into the case 2. As a result of the above, the nonaqueous electrolyte battery of the third example shown in FIGS. 7 to 9 can exhibit a long useful life.

Furthermore, in the nonaqueous electrolyte battery 1 of the third example, a part of the housing part 4a-1 of the positive electrode lead electrically connected to the electrode group 3 is exposed through the opening part 22C, formed in the second zone 22B₁ of the lead-sandwiching part 2B₁. Similarly, a part of the housing part 4b-1 of the negative electrode lead electrically connected to the electrode group 3 is exposed through the opening part 22C_{b} formed in the second zone 22B₂ of the lead-sandwiching part 2B₂. Therefore, the nonaqueous electrolyte battery 1 of the present Example can easily and certainly obtain electrical connection between the nonaqueous electrolyte battery 1 and an electronic device and/or other battery.

In the nonaqueous electrolyte battery according to the first embodiment described above, the case includes the housing part, the sealed part formed in the peripheral portion of the case, and the lead-sandwiching part positioned between the housing part and the sealed part. The electrode lead is sandwiched between the first zone and the second zone of the lead-sandwiching part. A part of the electrode lead is exposed through the opening part formed in the lead-sandwiching part.

Therefore, the nonaqueous electrolyte battery can prevent moisture contact occurring in the electrode group housed in the case. This means that deterioration of the nonaqueous electrolyte battery can be prevented. Therefore, the nonaqueous electrolyte battery can exhibit a long useful life. The nonaqueous electrolyte battery according to the first embodiment can easily and certainly obtain electrical connection between the nonaqueous electrolyte battery and an electronic device and/or other battery through the portion of the electrode lead exposed through the opening part of the lead-sandwiching part.

### Second Embodiment

According to a second embodiment, there is provided a battery module. The battery module includes at least two nonaqueous electrolyte batteries according to the first embodiment. The battery module further includes a bus bar. The bus bar is electrically connected between a portion of the electrode lead of one of the at least two nonaqueous electrolyte battery and a portion of the electrode lead of another of the at least two nonaqueous electrolyte battery. Each of the portions connected to each other is exposed through an opening part of a lead-sandwiching part.

As previously described, the nonaqueous electrolyte battery according to the first embodiment can easily and certainly obtain electrical connection between the nonaqueous electrolyte battery and an electronic device and/or other battery through the portion of the electrode lead exposed through the opening part of the lead-sandwiching part. Therefore, the battery module according to the second embodiment can also realise reliable electrical connections.

Also, the nonaqueous electrolyte battery according to the first embodiment can exhibit a long useful life. Therefore, the battery module according to the second embodiment can exhibit a long useful life.

Next, some examples of the battery module according to the second embodiment will be described with reference to the drawings.

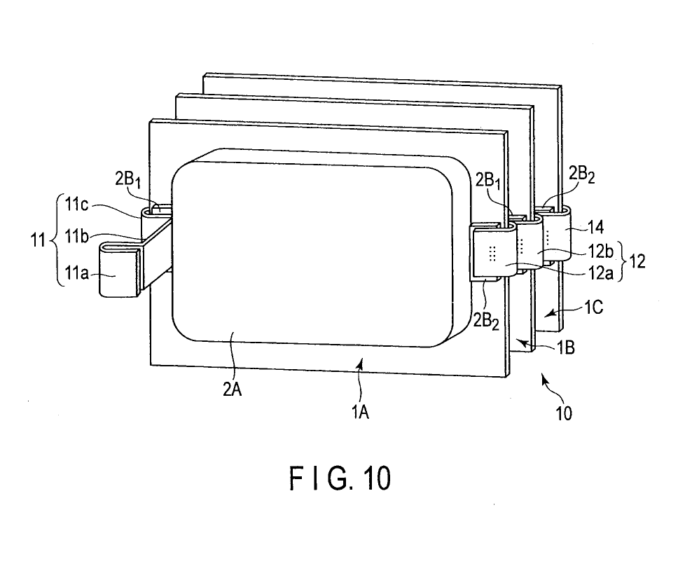

First, a battery module of a first example will be described with reference to FIGS. 10 to 12.

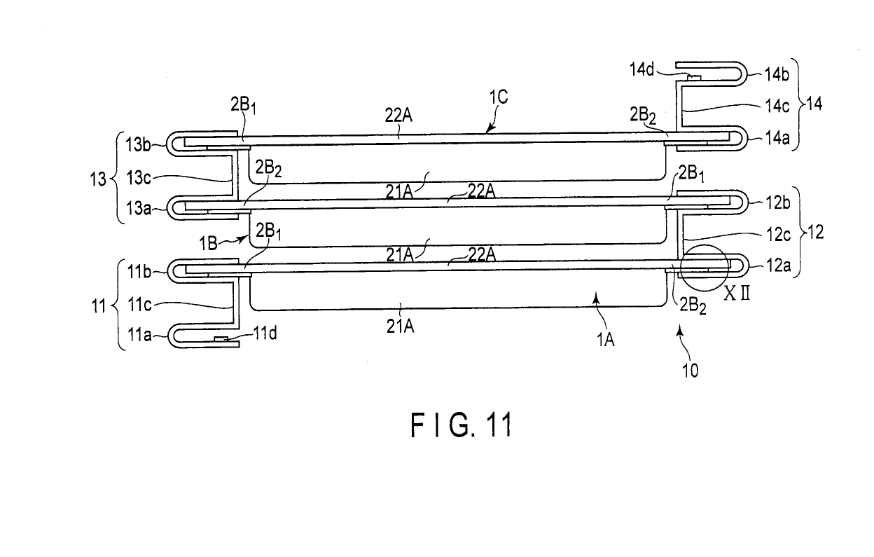

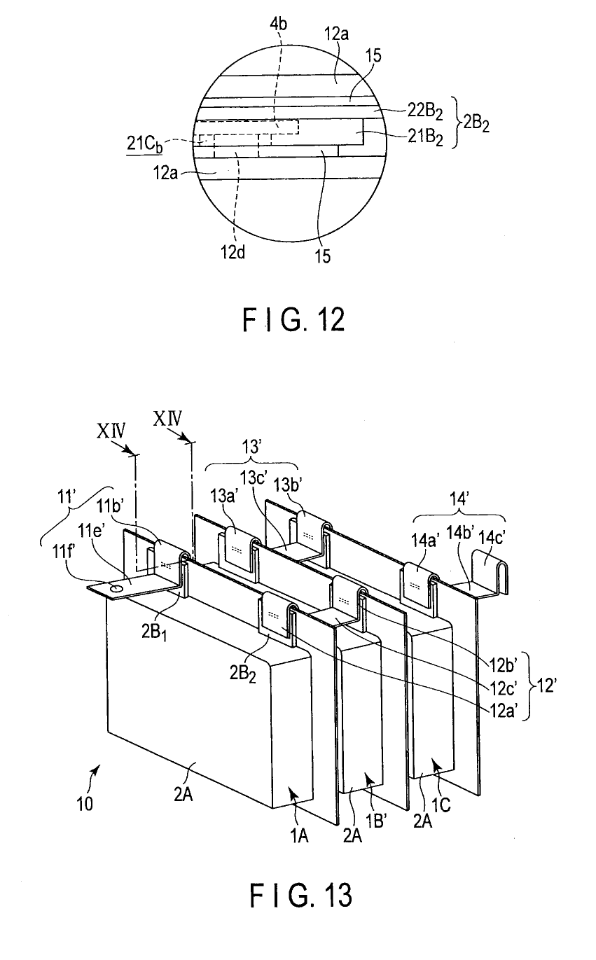

FIG. 10 is a schematic perspective view of the battery module of the first example according to the second embodiment. FIG. 11 is a schematic plan view of the battery module shown in FIG. 10. FIG. 12 is an enlarged transparent view of a portion XII of FIG. 11.

A battery module 10 of the first example shown in FIGS. 10 to 12 includes three nonaqueous electrolyte batteries 1A to 1C. These first to third nonaqueous electrolyte batteries 1A to 1C are the nonaqueous electrolyte batteries of the first example according to the first embodiment described with reference to FIGS. 1 to 5.

As shown in FIGS. 10 and 11, the first to third nonaqueous electrolyte batteries 1A to 1C are disposed so that a concave part 21A of a case body of the second nonaqueous electrolyte battery 1B is opposed to a portion 22A of a lid of the first nonaqueous electrolyte battery 1A, and a concave part 21A of a case body of the third nonaqueous electrolyte battery 1C is opposed to a portion 22A of a lid of the second nonaqueous electrolyte battery 1B. As shown in FIGS. 10 and 11, the first to third nonaqueous electrolyte batteries 1A to 1C are disposed so that a lead-sandwiching part 2B₁ of the first nonaqueous electrolyte battery 1A is opposed to a lead-sandwiching part 2B₂ of the second nonaqueous electrolyte battery 1B and a lead-sandwiching part 2B₁ of the third nonaqueous electrolyte battery 1C, and a lead-sandwiching part 2B₂ of the first nonaqueous electrolyte battery 1A is opposed to a lead-sandwiching part 2B₁ of the second nonaqueous electrolyte battery 1B and a lead-sandwiching part 2B₂ of the third nonaqueous electrolyte battery 1C.

The battery module 10 shown in FIGS. 10 to 12 further includes four bus bars 11 to 14.

The first to fourth bus bars 11 to 14 are metal members, and are electrically conductive.

As shown in FIGS. 10 and 11, the first bus bar 11 includes a first holding part 11a, a second holding part 11b, and a connecting part 11c connecting the first holding part 11a and the second holding part 11b.

The first holding part 11a includes two metal plates opposed to each other. One of the metal plates includes a projection 11d provided thereon. The first holding part 11a can be easily connected to the external terminal (not shown) of an electronic device and/or other battery by via the projection 11d. Furthermore, the projection 11d can prevent disconnection of the first holding part 11a and external terminal of the electronic device and/or other battery.

Similarly, the second holding part 11b includes two metal plates. One of the metal plates includes a projection (not shown) provided thereon.

The second bus bar 12, the third bus bar 13, and the fourth bus bar 14 also respectively include first holding parts 12a, 13a, and 14a, second holding parts 12b, 13b, and 14b, and connecting parts 12c, 13c, and 14c respectively connecting the first holding parts and the second holding parts, as in the first bus bar 11. The first and second holding parts 12a, 12b, 13a, 13b, 14a, and 14b of the second to fourth bus bars 12 to 14 respectively include two metal plates opposed to each other, as in the first and second holding parts 11a and 11b of the first bus bar 11. One of the metal plates includes a projection provided thereon. The projections other than a projection 12d provided on the first holding part 12a of the second bus bar 12 and a projection 14d provided on the second holding part 14b of the fourth bus bar 14 are not shown.

As shown in FIGS. 10 and 11, the two metal plates of the second holding part 11b of the first bus bar 11 hold the lead-sandwiching part 2B₁ of the first nonaqueous electrolyte battery 1A. Herein, an insulating members which are not shown are provided between each of the two metal plates of the second holding part 11b and the lead-sandwiching part 2B₁. Therefore, the first bus bar 11 is insulated from the lead-sandwiching part 2B₁ of the first nonaqueous electrolyte battery 1A.

As shown in FIGS. 10 to 12, the two metal plates of the first holding part 12a of the second bus bar 12 hold the lead-sandwiching part 2B₂ of the first nonaqueous electrolyte battery 1A in a state where insulating members 15 are disposed between each of the metal plates and each of a first zone 21B₂ and a second zone 22B₂ of the lead-sandwiching part 2B₂. Similarly, the two metal plates of the second holding part 12b of the second bus bar 12 hold the lead-sandwiching part 2B₁ of the second nonaqueous electrolyte battery 1B in a state where insulating members which are not shown are disposed between each of the metal plates and the lead holding part 2B₁.

As shown in FIG. 10 and FIG. 11, the first holding part 13a of the third bus bar 13 holds the lead-sandwiching part 2B₂ of the second nonaqueous electrolyte battery 1B in a state where insulating members which are not shown are disposed between the first holding part 13a and the lead-sandwiching part 2B₂. Similarly, the second holding part 13b of the third bus bar 13 holds the lead-sandwiching part 2B₁ of the third nonaqueous electrolyte battery 1C in a state where insulating members which are not shown are disposed between the second holding part 13b and the lead holding part 2B₁.

As shown in FIGS. 10 and 11, the first holding part 14a of the fourth bus bar 14 holds the lead-sandwiching part 2B₂ of the third nonaqueous electrolyte battery 1C in a state where insulating members which are not shown are disposed between the first holding part 14a and the lead-sandwiching part 2B₂.

Herein, the projection provided on one metal plate of the holding part of each of the first to fourth bus bars 11 to 14 is inserted into an opening part formed in the lead-sandwiching part 2B₁ or 2B₂ of the first to third nonaqueous electrolyte batteries 1A to 1C.

For example, as shown in FIG. 12, which is an enlarged view showing a portion for the first holding part 12a of the second bus bar 12, the projection 12d provided on one metal plate of the first holding part 12a of the second bus bar 12 is inserted into an opening part 21C_{b} of the lead-sandwiching part 2B₂ of the first nonaqueous electrolyte battery 1A. The projection 12d is welded to a negative electrode lead 4b sandwiched between a first zone and a second zone (not shown) of the lead-sandwiching part 2B₂. Thereby, the second bus bar 12 is electrically connected to the negative electrode lead 4b of the first nonaqueous electrolyte battery 1A.

The other projections provided on the first to fourth bus bars 11 to 14 are not shown. However, the other projections are the same as that provided on the first holding part 12a of the second bus bar 12. That is, the projection provided on the second holding part 11b of the first bus bar 11 is inserted into an opening part (not shown) provided on the lead-sandwiching part 2B₁ of the first nonaqueous electrolyte battery 1A. The projection is welded to a positive electrode lead (not shown) sandwiched between a first zone and a second zone (not shown) of the lead holding part 2B₁. Thereby, the first bus bar 11 is electrically connected to the positive electrode lead of the first nonaqueous electrolyte battery 1A. The projection provided on the second holding part 12b of the second bus bar 12 is inserted into an opening part (not shown) formed in the lead-sandwiching part 2B₁ of the second nonaqueous electrolyte battery 1B. The projection is welded to a positive electrode lead (not shown) sandwiched between a first zone and a second zone (not shown) of the lead-sandwiching part 2B₁. Thereby, the second bus bar 12 is electrically connected to the positive electrode lead of the second nonaqueous electrolyte battery 1B. The projection provided on the first holding part 13a of the third bus bar 13 is inserted into an opening part (not shown) formed in the lead-sandwiching part 2B₂ of the second nonaqueous electrolyte battery 1B. The projection is welded to a negative electrode lead (not shown) sandwiched between a first zone and a second zone (not shown) of the lead-sandwiching part 2B₂. Thereby, the third bus bar 13 is electrically connected to the negative electrode lead of the second nonaqueous electrolyte battery 1B. The projection provided on the second holding part 13b of the third bus bar 13 is inserted into an opening part (not shown) formed in the lead-sandwiching part 2B₁ of the third nonaqueous electrolyte battery 1C. The projection is welded to a positive electrode lead (not shown) sandwiching a first zone and a second zone (not shown) of the lead holding part 2B₁. Thereby, the third bus bar 13 is electrically connected to the positive electrode lead of the third nonaqueous electrolyte battery 1C. The projection provided on the first holding part 14a of the fourth bus bar 14 is inserted into an opening part (not shown) formed in the lead-sandwiching part 2B₂ of the third nonaqueous electrolyte battery 1C. The projection is welded to a negative electrode lead (not shown) sandwiched between a first zone and a second zone (not shown) of the lead-sandwiching part 2B₂. Thereby, the fourth bus bar is electrically connected to the negative electrode lead of the third nonaqueous electrolyte battery 1C.

As in the first bus bar 11, the second holding part 14b of the fourth bus bar 14 includes a projection 14d provided thereon, as shown in FIG. 11. The second holding part 14b of the fourth bus bar 14 can be easily connected to the external terminal of an electronic device and/or other battery via the projection 14d. Furthermore, the projection 14d can prevent the disconnection of the fourth bus bar 14 and external terminal of the electronic device and/or other battery.

Thus, in the battery module 10 of the first example shown in FIGS. 10 to 12, the first to third nonaqueous electrolyte batteries 1A to 1C are electrically connected in series by the second and third bus bars 12 and 13. The battery module 10 of the first example shown in FIGS. 10 to 12 can obtain electrical connection between the battery module 10 and an electronic device and/or other battery through the first holding part 11a of the first bus bar 11, and the second holding part 14b of the fourth bus bar 14.

As previously described with reference to FIGS. 1 to 5, the first to third nonaqueous electrolyte batteries 1A to 1C can exhibit a long useful life.

Therefore, the battery module 10 of the first example shown in FIGS. 10 to 12 can exhibit a long useful life.

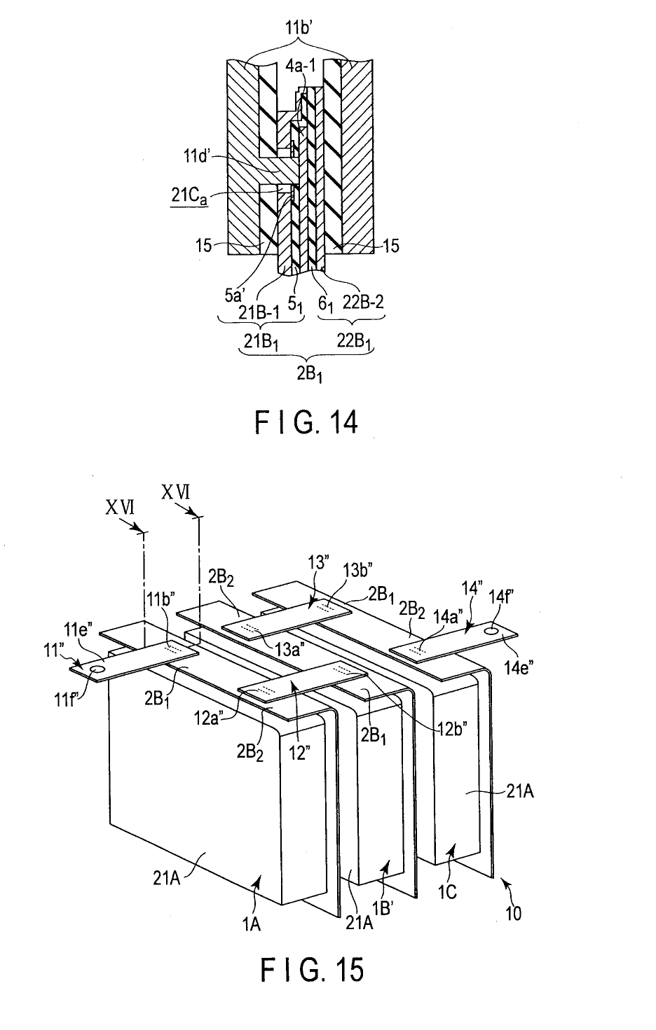

Next, a battery module of a second example will be described with reference to FIGS. 13 and 14.

FIG. 13 is a schematic perspective view of the battery module of the second example according to the second embodiment. FIG. 14 is a schematic sectional view taken along line XIV-XIV of the battery module shown in FIG. 13.

The battery module of the second example shown in FIGS. 13 and 14 includes three nonaqueous electrolyte batteries 1A, 1B′, and 1C.

The first nonaqueous electrolyte battery 1A and the third nonaqueous electrolyte battery 1C are the nonaqueous electrolyte batteries of the second example according to the first embodiment described with reference to FIG. 6. The second nonaqueous electrolyte battery 1B′ has the same structure as that of the nonaqueous electrolyte battery of the second example according to the first embodiment except that the positions of a positive electrode lead and a negative electrode lead are exchanged.

As shown in FIG. 13, the first to third nonaqueous electrolyte batteries 1A, 1B′, and 1C are disposed so that a lead-sandwiching part 2B₁ of the first nonaqueous electrolyte battery 1A is opposed to a lead-sandwiching part 2B₂ of the second nonaqueous electrolyte battery 1B′ and a lead-sandwiching part 2B₁ of the third nonaqueous electrolyte battery 1C, and a lead-sandwiching part 2B₂ of the first nonaqueous electrolyte battery 1A is opposed to a lead-sandwiching part 2B₁ of the second nonaqueous electrolyte battery 1B′ and a lead-sandwiching part 2B₂ of the third nonaqueous electrolyte battery 1C.

The battery module 10 shown in FIGS. 13 and 14 further includes four bus bars 11′ to 14′.

The first bus bar 11′ includes a holding part 11b′ and an external connecting terminal 11e′ electrically connected to the holding part 11b′.

The holding part 11b′ includes two metal plates. As shown in FIG. 14, a projection 11d′ is provided on one of the two metal plates of the holding part 11b′.

The holding part 11b′ holds a first zone 2B′ of the first nonaqueous electrolyte battery 1A, as shown in FIGS. 13 and 14. In detail, as shown in FIG. 14, the two metal plates of the holding part 11b′ hold the lead-sandwiching part 2B₁ of the first nonaqueous electrolyte battery 1A. Herein, an insulating member 15 is disposed between one of the metal plates and a first zone 21B₁ of the lead-sandwiching part 2B₁. The other insulating member 15 is disposed between the other metal plate and a second zone 22B₁. As shown in FIG. 14, the projection 11d′ provided on one of the metal plates of the holding part 11b′ is inserted into an opening part 21Cₐ of the lead-sandwiching part 2B₁ of the first nonaqueous electrolyte battery 1A. The projection 11d′ is welded to a housing part 4a-1 of the positive electrode lead sandwiched between a first zone and a second zone (not shown) of the lead-sandwiching part 2B₁. Thereby, the first bus bar 11′ is electrically connected to the housing part 4a-1 of the positive electrode lead of the first nonaqueous electrolyte battery 1A. As can be seen from the description of the nonaqueous electrolyte battery of the second example according to the first embodiment, the lead-sandwiching part 2B₁ of the first nonaqueous electrolyte battery 1A, which is the nonaqueous electrolyte battery of the second example of the first embodiment, has the same structure as that of the lead-sandwiching part 2B₁ included in the nonaqueous electrolyte battery of the first example of the first embodiment, and has the same cross-sectional structure as that of the section shown in FIG. 2. Therefore, in FIG. 14, the same reference numerals as those in FIG. 2 denote the same members as those shown in FIG. 2, and a description thereof is not repeated hereinafter.

The external connecting terminal 11e′ of the first bus bar 11′ has an opening part 11f′. The external connecting terminal 11e′ can be easily and firmly connected to the external terminal of an electronic device and/or other battery by screwing of the external connecting terminal 11e′ via the opening part 11f′, for example.

The second bus bar 12′ includes a first holding part 12a′, a second holding part 12b′, and a connecting part 12c′ connecting the first holding part 12a′ and the second holding part 12b′. The third bus bar 13′ includes a first holding part 13a′, a second holding part 13b′, and a connecting part 13c′ connecting the first holding part 13a′ and the second holding part 13b′. The first holding part 12a′ and the second holding part 12b′ of the second bus bar 12′, and the first holding part 13a′ and second the holding part 13b′ of the third bus bar 13′ include two metal plates opposed to each other. In each holding part of the second bus bar 12′ and the third bas bar 13′, one of the metal plates includes a projection (not shown) provided thereon. That is, these holding parts have the same structure as that of the holding part 11b′ of the first bus bar 11′.

As shown in FIG. 13, in the second bus bar 12′, the first holding part 12a′ holds the lead-sandwiching part 2B₂ of the first nonaqueous electrolyte battery 1A, and the second holding part 12b′ holds the lead-sandwiching part 2B₁ of the second nonaqueous electrolyte battery 1B′. As shown in FIG. 13, in the third bus bar 13′, the first holding part 13a′ holds the lead-sandwiching part 2B₂ of the second nonaqueous electrolyte battery 1B′, and the second holding part 13b′ holds the lead-sandwiching part 2B₁ of the third nonaqueous electrolyte battery 1C.

Herein, the projection provided on one of the metal plates of each holding part of the second and third bus bars 12′ and 13′ is inserted into an opening part (not shown) formed in the lead-sandwiching part 2B₁ or 2B₂ of the first, second, or third nonaqueous electrolyte battery 1A, 1B′, or 1C, as in the projection of the holding part 11b′ of the first bus bar 11′ described with reference to FIG. 14. The projection is welded to a housing part (not shown) of the positive electrode lead sandwiched between a first zone and a second zone (not shown) of the lead-sandwiching part 2B₁, or a housing part (not shown) of the negative electrode sandwiched between a first zone and a second zone of the lead-sandwiching part 2B₂. In the structure, the first to third nonaqueous electrolyte batteries 1A, 1B′, and 1C are electrically connected in series through the second and third bus bars 12′ and 13′.

As shown in FIG. 13, the fourth bus bar 14′ includes a first holding part 14a′, a second holding part 14b′, and a connecting part 14c′ connecting the first holding part 14a′ and the second holding part 14b′, as in the second bus bar 12′ and the third bus bar 13′. The first and second holding parts 14a′ and 14b′ of the fourth bus bar 14′ include two metal plates opposed to each other. In each holding part of the fourth bus bar 14′, one of the metal plates includes a projection (not shown) provided thereon.

The first holding part 14a′ of the fourth bus bar 14′ holds the lead-sandwiching part 2B₂ of the third nonaqueous electrolyte battery 1C. The projection provided on one of the metal plates is inserted into an opening part (not shown) formed in the lead-sandwiching part 2B₂ of the third nonaqueous electrolyte battery 1C, as in the projection of the holding part 11b′ of the first bus bar 11′ described with reference to FIG. 14. The projection is welded to a housing part (not shown) of the negative electrode lead sandwiched between a first zone and a second zone (not shown) of the lead-sandwiching part 2B₂. Thereby, the fourth bus bar 14′ is electrically connected to the negative electrode lead of the third nonaqueous electrolyte battery 1C.

The second holding part 14b′ of the fourth bus bar 14′ can be easily connected to the external terminal of an electronic device and/or other battery via a projection which is not shown, for example. The projection can prevent the disconnection of the fourth bus bar 14′ and external terminal of the electronic device and/or other battery.

The first to third nonaqueous electrolyte batteries 1A, 1B′, and 1C can exhibit a long useful life, as previously described with reference to FIG. 6. Therefore, the battery module 10 of the second example shown in FIGS. 13 and 14 can exhibit a long useful life.

Furthermore, the first to third nonaqueous electrolyte batteries 1A, 1B′, and 1C can easily and certainly obtain electrical connection between the first to third nonaqueous electrolyte batteries 1A, 1B′, and 1C, and an electronic device and/or other battery through the external connecting terminal 11e′ of the first bus bar 11 and the second holding part 14b′ of the fourth bus bar 14′.

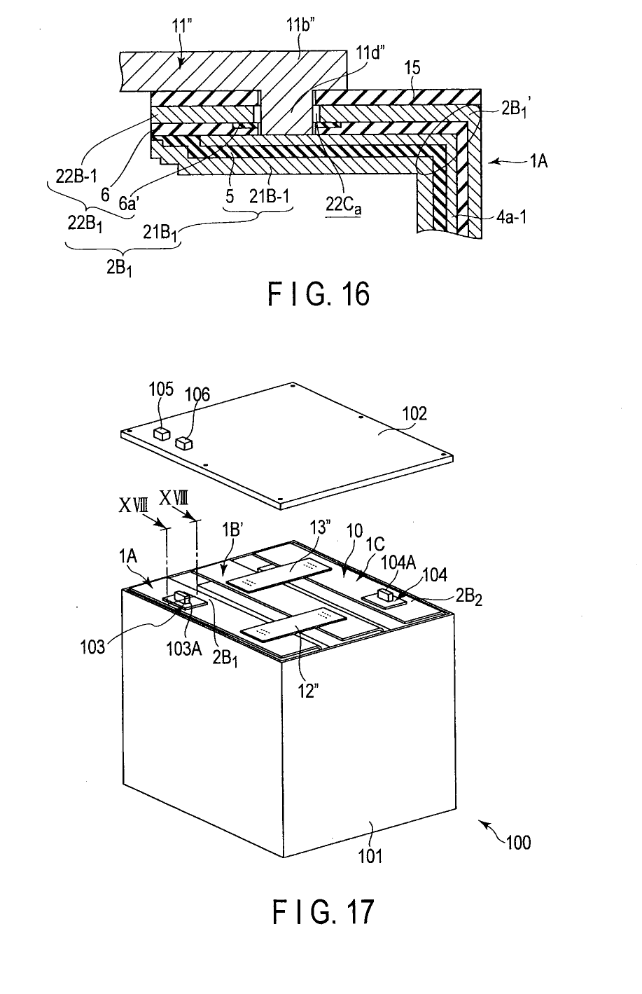

Next, a battery module of a third example will be described with reference to FIGS. 15 and 16.

FIG. 15 is a schematic perspective view of the battery module of the third example according to the second embodiment. FIG. 16 is a schematic sectional view taken along line XVI-XVI of the battery module shown in FIG. 15.

The battery module of the third example shown in FIGS. 15 and 16 includes three nonaqueous electrolyte batteries, 1A, 1B′, and 1C.

The first nonaqueous electrolyte battery 1A and the third nonaqueous electrolyte battery 1C are the nonaqueous electrolyte batteries of the third example according to the first embodiment described with reference to FIGS. 7 to 9. The second nonaqueous electrolyte battery 1B′ has the same structure as that of the nonaqueous electrolyte battery of the third example according to the first embodiment except that the positions of a positive electrode lead and a negative electrode lead are exchanged.

As shown in FIG. 15, the first to third nonaqueous electrolyte batteries 1A, 1B′, and 1C are disposed so that a concave part 21A of a case body of the second nonaqueous electrolyte battery 1B′ is opposed to a lid (not shown) of the first nonaqueous electrolyte battery 1A, and a concave part 21A of a case body of the third nonaqueous electrolyte battery 1C is opposed to a lid (not shown) of the second nonaqueous electrolyte battery 1B′.

A battery module 10 shown in FIGS. 15 and 16 further includes four bus bars 11″ to 14″.

The first bus bar 11″ includes a lead connecting part 11b″, and an external connecting terminal 11e″ electrically connected to the lead connecting part 11b″.

The lead connecting part 11b″ includes a projection 11d″ provided thereon, as shown in FIG. 16. The projection 11d″ is inserted into an opening part 22Cₐ formed in a second zone 22B₁ of a lead-sandwiching part 2B₁ of the first nonaqueous electrolyte battery 1A. The projection 11d″ is welded to a housing part 4a-1 of a positive electrode lead sandwiched between the first zone 21B₁ and the second zone 22B₁ of the lead-sandwiching part 2B₁. Thereby, the first bus bar 11″ is electrically connected to the housing part 4a-1 of the positive electrode lead of the first nonaqueous electrolyte battery 1A. Herein, an insulating member 15 is disposed between the lead connecting part 11b″ and the lead-sandwiching part 2B₁, as shown in FIG. 16. Therefore, the first bus bar 11″ is electrically insulated from a first zone 21B₁ and a second zone 21B₂ of the lead-sandwiching part 2B₁. The lead-sandwiching part 2B₁ of the nonaqueous electrolyte battery 1A, which is the nonaqueous electrolyte battery of the third example according to the first embodiment, has the same structure as that of the lead-sandwiching part 2B₂, as can be learnt from the description of the nonaqueous electrolyte battery of the third example, and has the same cross-sectional structure as that of the section of the lead-sandwiching part 2B₂ shown in FIG. 8. Therefore, in FIG. 16, the corresponding numerals denote members corresponding to the members shown in FIG. 8, and a description thereof is not repeated hereinafter.

The external connecting terminal 11e″ has an opening part 11f″. The external connecting terminal 11e″ can be easily and firmly connected to the external terminal of an electronic device and/or other battery by screwing the external connecting terminal 11e″ via the opening part 11f″, for example.

The second bus bar 12″ includes a first lead connecting part 12a″ and a second lead connecting part 12b″ electrically connected to the first lead connecting part 12a″. Each of the first and second lead connecting parts 12a″ and 12b″ of the second bus bar 12″ include a projection (not shown) provided thereon.

The projection provided on the first lead connecting part 12a″ of the second bus bar 12″ is inserted into an opening part (not shown) formed in the lead-sandwiching part 2B₂ of the first nonaqueous electrolyte battery 1A, as in the projection 11d″ provided on the lead connecting part 11b″ of the first bus bar 11″. The projection is welded to a housing part (not shown) of the negative electrode lead sandwiched between a first zone and a second zone (not shown) of the lead-sandwiching part 2B₂. Thereby, the second bus bar 12″ is electrically connected to the housing part of the negative electrode lead of the first nonaqueous electrolyte battery 1A. The projection provided on the second lead connecting part 12b″ of the second bus bar 12″ is inserted into an opening part (not shown) formed in the lead-sandwiching part 2B₁ of the second nonaqueous electrolyte battery 1B′, as in the projection 11d″ provided on the lead connecting part 11b″ of the first bus bar 11″. The projection is welded to a housing part (not shown) of the positive electrode lead sandwiched between a first zone and a second zone of the lead-sandwiching part 2B₁. Thereby, the second bus bar 12″ is electrically connected to the housing part of the positive electrode lead of the second nonaqueous electrolyte battery 1B′.

The third bus bar 13″ has the same structure as that of the second bus bar 12″. That is, the third bus bar 13″ includes a first lead connecting part 13a″, and a second lead connecting part 13b″ electrically connected to the first lead connecting part 13a″. Each of the first and second lead connecting parts 13a″ and 13b″ of the third bus bar 13″ include a projection (not shown) provided thereon.

The projection provided on the first lead connecting part 13a″ of the third bus bar 13″ is inserted into an opening part (not shown) formed in the lead-sandwiching part 2B₂ of the second nonaqueous electrolyte battery 1B′, as in the projection 11d″ provided on the lead connecting part 11b″ of the first bus bar 11″. The projection is welded to a housing part (not shown) of the negative electrode lead sandwiched between a first zone and a second zone (not shown) of the lead-sandwiching part 2B₂. Thereby, the third bus bar 13″ is electrically connected to the housing part of the negative electrode lead of the second nonaqueous electrolyte battery 1B′. The projection provided on the second lead connecting part 13b″ of the third bus bar 13″ is inserted into an opening part (not shown) formed in the lead-sandwiching part 2B₁ of the third nonaqueous electrolyte battery 1C, as in the projection 11d″ provided on the lead connecting part 11b″ of the first bus bar 11″. The projection is welded to a housing part (not shown) of the positive electrode lead sandwiched between a first zone and a second zone (not shown) of the lead holding part 2B₁. Thereby, the third bus bar 13″ is electrically connected to the housing part of the positive electrode lead of the third nonaqueous electrolyte battery 1C.

The fourth bus bar 14″ has the same structure as that of the first bus bar 11″. That is, the fourth bus bar 14″ includes a lead connecting part 14a″, and an external connecting terminal 14e″ electrically connected to the lead connecting part 14a″.

The lead connecting part 14a″ of the fourth bus bar 14″ includes a projection (not shown) provided thereon. The projection is inserted into an opening part (not shown) formed in the lead-sandwiching part 2B₂ of the third nonaqueous electrolyte battery 1C, as in the projection 11d″ provided on the lead connecting part 11b″ of the first bus bar 11″. The projection is welded to a housing part (not shown) of the negative electrode lead sandwiched between a first zone and a second zone (not shown) of the lead holding part 2B₂. Thereby, the fourth bus bar 14″ is electrically connected to the housing part of the negative electrode lead of the third nonaqueous electrolyte battery 1C.

The external connecting terminal 14e″ of the fourth bus bar 14″ has an opening part 14f″. The external connecting terminal 14e″ can be easily and firmly connected to the external terminal of an electronic device and/or other battery by screwing the external connecting terminal 14e″ via the opening part 14f″ into the external terminal, for example.

Thus, in the battery module 10 of the third example shown in FIGS. 15 and 16, the first to third nonaqueous electrolyte batteries 1A, 1B′, and 1C are electrically connected in series by the second and third bus bars 12′″ and 13″. The battery module 10 of the third example shown in FIGS. 15 and 16 can obtain electrical connection between the battery module 10 and an electronic device and/or other battery through the external connecting terminal 11e″ of the first bus bar 11″ and the external connecting terminal 14e″ of the fourth bus bar 14″.

The first to third nonaqueous electrolyte batteries 1A to 1C can exhibit a long useful life, as previously described with reference to FIGS. 6 and 7.

Therefore, the battery module 10 of the third example shown in FIGS. 15 and 16 can exhibit a long useful life.

According to the second embodiment described above, there is provided a battery module. The battery module includes the plurality of nonaqueous electrolyte batteries according to the first embodiment. Therefore, the battery module according to the second embodiment can easily and certainly obtain electrical connection between the battery module and an electronic device and/or other battery, and can exhibit a long useful life.

### Third Embodiment

According to a third embodiment, there is provided a battery apparatus. The battery apparatus includes the battery module according to the second embodiment, and an outer case which houses the battery module.

The material and shape or the like of the outer case included in the battery apparatus according to the third embodiment are not particularly limited, and can be freely selected depending upon the application.

Since the battery apparatus according to the third embodiment includes the battery module according to the second embodiment, the battery apparatus can easily and certainly obtain electrical connection between the storage battery apparatus and an electronic device and/or other battery, and can exhibit a long useful life.

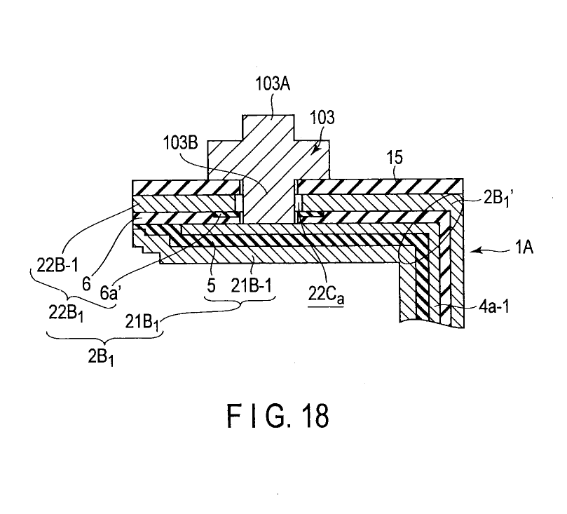

Next, an example of the battery apparatus according to the third embodiment will be described in detail with reference to FIGS. 17 and 18.

FIG. 17 is a schematic exploded perspective view of the battery apparatus of an example according to the third embodiment. FIG. 18 is a schematic sectional view taken along line XVIII-XVIII of the battery apparatus shown in FIG. 17.

A battery apparatus 100 shown in FIGS. 17 and 18 includes a battery module 10. The battery module 10 is prepared by partially altering the battery module 10 of the third example according to the second embodiment described with reference to FIGS. 15 and 16. That is, the battery module 10 included in the storage battery apparatus 100 shown in FIG. 17 includes three nonaqueous electrolyte batteries 1A, 1B′, and 1C. The battery module 10 further includes a second bus bar 12″ and a third bus bar 13″. The second bus bar 12″ and the third bus bar 13″ electrically connects the three nonaqueous electrolyte batteries 1A, 1B′, and 1C in series as in the second bus bar 12″ and the third bus bar 13″ of the battery module 10 of the third example according to the second embodiment shown in FIGS. 15 and 16.

The battery module 10 included in the storage battery apparatus 100 shown in FIGS. 17 and 18 is different from the battery module 10 of the third example according to the second embodiment described with reference to FIGS. 15 and 16 in that the battery module 10 does not include a first bus bar and a fourth bus bar. Instead, the battery module 10 included in the storage battery apparatus 100 shown in FIG. 17 includes a positive electrode terminal connecting part 103 and a negative electrode terminal connecting part 104.

As shown in FIG. 18, the positive electrode terminal connecting part 103 includes two principal surfaces having a rectangular plane shape. The section of the positive electrode terminal connecting part 103 is shown in FIG. 18. The positive electrode terminal connecting part 103 includes one principal surface having a projection 103A provided thereon, and the other principal surface having a projection 103B provided thereon. The positive electrode terminal connecting part 103 is made of a conductive material. For example, the positive electrode terminal connecting part 103 may be made of a metal.

As shown in FIG. 18, one projection 103B of the positive electrode terminal connecting part 103 is inserted into an opening part 22Cₐ formed in a second zone 22B₁ of a lead-sandwiching part 2B₁ of the first nonaqueous electrolyte battery 1A. The projection 103B is welded to a housing part 4a-1 of a positive electrode lead between the first zone 21B₁ and the second zone 22B₁ of the lead holding part 2B₁. Thereby, the positive electrode terminal connecting part 103 is electrically connected to the housing part 4a-1 of the positive electrode lead sandwiched between a first zone 21B₁ and the second zone 22B₁.

Herein, as shown in FIG. 18, the positive electrode terminal connecting part 103 is not directly in contact with the second zone 22B₁ of the lead-sandwiching part 2B₁ of the first nonaqueous electrolyte battery 1A. An insulating member 15 is disposed between the positive electrode terminal connecting part 103 and the second zone 22B₁. Therefore, the positive electrode terminal connecting part 103 is electrically insulated from the lead-sandwiching part 2B₁ of the first nonaqueous electrolyte battery 1A.

The negative electrode terminal connecting part 104 has the same structure as that of the positive electrode terminal connecting part 103. That is, the negative electrode terminal connecting part 104 includes two principal surfaces having a rectangular plane shape. The negative electrode terminal connecting part 104 includes one principal surface having a projection 104A provided thereon, and the other principal surface having a projection (not shown) provided thereon. The negative electrode terminal connecting part 104 is made of a conductive material. For example, the negative electrode terminal connecting part 104 may be made of a metal.

One projection (not shown) of the negative electrode terminal connecting part 104 is inserted into an opening part (not shown) formed in a lead-sandwiching part 2B₂ of the third nonaqueous electrolyte battery 1C, as in one projection 103B of the positive electrode terminal connecting part 103 described with reference to FIG. 18. The projection is welded to a housing part (not shown) of a negative electrode lead sandwiched between a first zone and a second zone (not shown) of the lead-sandwiching part 2B₂. Thereby, the negative electrode terminal connecting part 104 is electrically connected to the housing part of the negative electrode lead of the third nonaqueous electrolyte battery 1C. The negative electrode terminal connecting part 104 is not directly in contact with the lead-sandwiching part 2B₂ of the third nonaqueous electrolyte battery 1C, as in the positive electrode terminal connecting part 103. An insulating member (not shown) is disposed between the negative electrode terminal connecting part 104 and the lead-sandwiching part 2B₂. Therefore, the negative electrode terminal connecting part 104 is electrically insulated from the lead-sandwiching part 2B₂ of the third nonaqueous electrolyte battery 1C.

The battery apparatus 100 shown in FIGS. 17 and 18 further includes an outer case 101. The outer case 101 is a hollow container having an almost cubic shape. The outer case 101 has one end having an opening. The outer case 101 is formed of a synthetic resin having insulation properties, for example, modified polyphenylene ether (m-PPE).

The battery module 10 previously described is housed in the outer case 101. The projection 103A of the positive electrode terminal connecting part 103 of the battery module 10 and the projection 104A of the negative electrode terminal connecting part 104 extend toward the opening of the outer case 101.

The battery apparatus 100 shown in FIG. 17 further includes a lid 102. The lid 102 includes two principal surfaces parallel to each other. The principal surfaces have a rectangular plane shape corresponding to the opening of the outer case 101. For example, the lid 102 may be made of a synthetic resin having the same insulation properties as those of the outer case 101, for example, PPE.

The lid 102 includes one principal surface having a positive electrode terminal 105 and a negative electrode terminal 106 provided thereon. The lid 102 includes the other principal surface having a positive electrode terminal wiring and a negative electrode terminal wiring (not shown) provided thereon. The positive electrode terminal wiring is electrically connected to the positive electrode terminal 105. Similarly, the negative electrode terminal wiring is electrically connected to the negative electrode terminal 106. The positive electrode terminal 105, the negative electrode terminal 106, the positive electrode terminal wiring, and the negative electrode terminal wiring are electrically insulated from the lid 102.

The lid 102 is fixed to the outer case 101 so that the outer case 101 is sealed, and so that the positive electrode terminal wiring and the negative electrode terminal wiring are opposed to the battery module 10.

The positive electrode terminal wiring is electrically connected to the projection 103A of the positive electrode terminal connecting part 103 of the battery module 10. Thus, the positive electrode terminal 105 and the positive electrode terminal connecting part 103 of the battery module 10 are electrically connected. Similarly, the negative electrode terminal wiring is connected to the projection 104A of the negative electrode terminal connecting part 104 of the battery module 10. Thus, the negative electrode terminal 106 and the negative electrode terminal connecting part 104 of the battery module 10 are electrically connected.

The battery apparatus 100 shown in FIG. 17 can be electrically connected to an external generator and/or an electronic device or the like through the positive electrode terminal 105 and the negative electrode terminal 106.

Since the battery apparatus according to the third embodiment described above includes the battery module according to the second embodiment, the battery apparatus can easily and certainly obtain electrical connection between the battery apparatus and an electronic device and/or other battery, and can exhibit a long useful life.

### Example

Hereinafter, an Example will be described. However, the following Example is not intended to limit the scope of the invention unless the gist of the invention is exceeded.

### Example

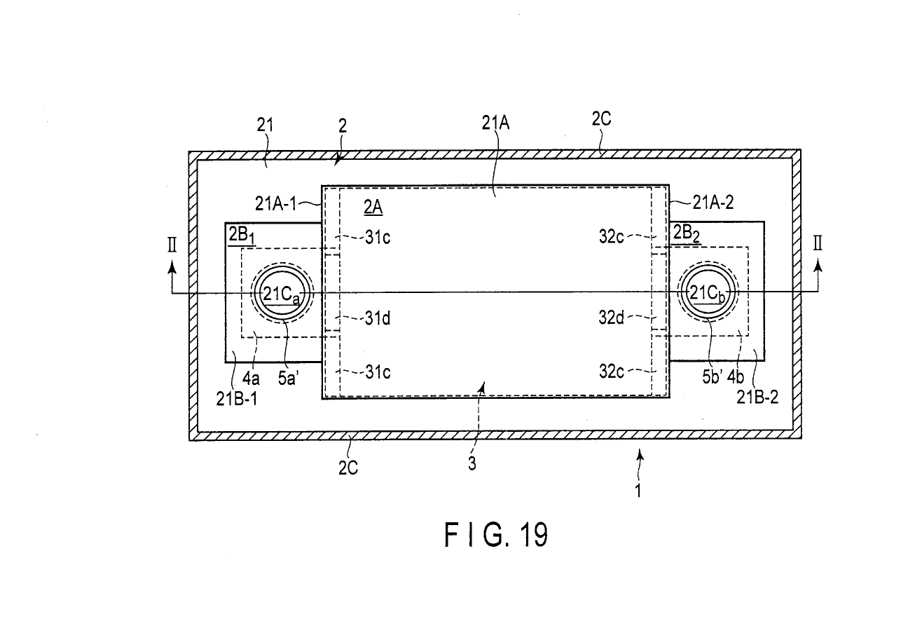

In the present Example, the same nonaqueous electrolyte battery 1 as a nonaqueous electrolyte battery 1 shown in FIGS. 1 to 5 is prepared in the following procedure except for the following points. That is, in the nonaqueous electrolyte battery 1 of the present Example, as shown in the schematic plan view of the nonaqueous electrolyte battery 1 in FIG. 19, a case 2 does not include a folded part. The case 2 includes four sealed parts 2C formed in four peripheral parts thereof. The sectional view taken along line II-II of the nonaqueous electrolyte battery 1 of the present Example shown in FIG. 19 is the same as the sectional view of the nonaqueous electrolyte battery of the first example according to the first embodiment shown in FIG. 2.

[Preparation of Electrode Group 3]

Preparation of Positive Electrode 31

By weight, 90% of lithium manganese oxide (LiMn_{1.9}Al_{0.1}O₄) powder having a spinel structure as a positive electrode active material, 5% of acetylene black as a conductive agent, and 5% of polyvinylidene fluoride (PVdF) were added to and mixed with N-methylpyrrolidone (NMP) to prepare a slurry. The slurry was then coated on both surfaces of a positive electrode current collector 31a made of an aluminum foil having a thickness of 15 μm, then dried and pressed to prepare a positive electrode having an electrode density of 2.9 g/cm³.

Thus, there was prepared a band-like positive electrode 31 including the positive electrode current collector 31a, a positive electrode material layer 31b supported on both surfaces of the positive electrode current collector 31a, and a positive-electrode-material-layer-non-supporting part 31c.

Preparation of Negative Electrode 32

By weight, 90% of lithium titanium oxide (Li₄Ti₅O₁₂) powder having a spinel structure as a negative electrode active material, 5% of acetylene black as a conductive agent, and 5% of polyvinylidene fluoride (PVdF) were added to and mixed with N-methylpyrrolidone (NMP) to prepare a slurry. The slurry was then coated on both surfaces of a negative electrode current collector 32a made of an aluminum foil having a thickness of 15 μm, then dried and pressed to prepare a negative electrode having an electrode density of 2.3 g/cm³.

Thus, there was prepared a band-like negative electrode 32 including the negative electrode current collector 32a, a negative electrode material layer 32b supported on both surfaces of the negative electrode current collector 32a, and a negative-electrode-material-layer-non-supporting part 32c.

Preparation of Electrode Group 3

Next, there was provided a separator having a thickness of 20 μm and including a polyethylene porous film as a separator 33.

Next, the band-like positive electrode 31 and the band-like negative electrode 32 were stacked with the separator 33 interposed therebetween, to form an electrode group assembly 3. In this case, the positive-electrode-material-layer-non-supporting part 31c and the negative-electrode-material-layer-non-supporting part 32c were extended in mutually opposite directions from the electrode group assembly 3.

Then, the electrode group assembly 3 was spirally wound. Next, a core was taken out from the electrode group assembly 3, and the electrode group assembly 3 was pressed into a flat shape.

Next, a part of the positive-electrode-material-layer-non-supporting part 31c was grasped a current collecting tab 31d of the positive electrode 31. In this state, the positive-electrode-material-layer-non-supporting part 31c and the current collecting tab 31d of the positive electrode 31 were subjected to ultrasonic welding. Similarly, a part of the negative-electrode-material-layer-non-supporting part 32c was grasped by a current collecting tab 32d of the negative electrode 32. In this state, the negative-electrode-material-layer-non-supporting part 32c and the current collecting tab 32d of the negative electrode 32 were subjected to ultrasonic welding.

Next, a portion excluding the positive-electrode-material-layer-non-supporting part 31c of the electrode group assembly 3, the current collecting tab 31d of the positive electrode 31, the negative electrode material layer-non-supporting part 32c, and the current collecting tab 32d of the negative electrode 32 were covered with an insulating tape 34.

Thus, there was obtained the wound-type electrode group 3 having the flat shape shown in FIGS. 3 and 4.

[Connection of Electrode Group 3 with Positive Electrode Lead 4a and Negative Electrode Lead 4b]

Next, two strip-shaped aluminum foils were provided as a positive electrode lead 4a and a negative electrode lead 4b. The provided positive electrode lead 4a was ultrasonically welded to the current collecting tab 31d of the positive electrode 31. Similarly, the provided negative electrode lead 4b was ultrasonically welded to the current collecting tab 32d of the negative electrode 32.

[Fabrication of Nonaqueous Electrolyte Battery 1]

Next, the case 2 shown in FIGS. 19 and 2 was provided.

The case 2 was made of stainless steel, and included a case body 21 and a lid 22. A concave part 21A, a concave part 21B-1, and a concave part 21B-2 shown in FIG. 2 were formed in the case body 21 by deep drawing processing. In the case body 21 prepared in the present Example, the four corners of the concave part 21A were rounded as shown in FIG. 5. As shown in FIGS. 19 and 2, the bottom parts of the concave part 21B-1 and the concave part 21B-2 had opening parts 21Cₐ and 21C_{b} passing through the bottom parts. The diameter of each of the opening parts 21Cₐ and 21C_{b} was 7 mm. An inlet which was not shown was formed in the concave part 21A. The lid 22 was separated from the case body 21. The lid 22 was a plate-like member having the same plane shape as that of the case body 21.

As shown in FIG. 2, an insulating ring 5a′ was disposed on the peripheral part of the opening part 21Cₐ in the bottom part of the concave part 21B-1. Similarly, an insulating ring 5b′ was disposed on the peripheral part of the opening part 21C_{b} in the bottom part of the concave part 21B-2. In the surface including the bottom faces of the concave part 21A, the concave part 21B-1, and the concave part 21B-2 of the case body 21, the entire surface excluding a portion on which the insulating rings 5a′ and 5b′ were disposed and the inlet formed in the concave part 21A was covered with a thermoplastic resin layer 5. The surfaces of the insulating rings 5a′ and 5b′ opposed to the lid 22 were also covered with the thermoplastic resin layer 5.

As shown in FIG. 2, the entire surface of the lid 22 opposed to the case body 21 was covered with a thermoplastic resin layer 6.

The electrode group 3 previously prepared was disposed in the concave part 21A of the case body 21 of the case 2.

Next, the case body 21 and the lid 22 of the case 2 were opposed to each other so that a part of the thermoplastic resin layer 5 and a part of thermoplastic resin layer 6 were in contact with each other.

Thereby, the electrode group 3 was housed in a housing part 2A of the case 2 including the concave part 21A of the case body 21 and a portion 22A of the lid 22 opposed to the concave part 21A.

In this case, the positive electrode lead 4a was sandwiched between a first zone 21B₁ of the case body 21 and a second zone 22B₁ of the lid 22 in a lead-sandwiching part 2B₁. Similarly, the negative electrode lead 4b was sandwiched between a first zone 21B₂ of the case body 21 and a second zone 22B₂ of the lid 22 in a lead-sandwiching part 2B₂.

Thus, the positive electrode lead 4a was in contact with a portion 5a which was a part of the thermoplastic resin layer 5 and covered the bottom face of the concave part 21B-1 of the case body 21, and a portion 6₁ which was a part of the thermoplastic resin layer 6 and covered the surface of a portion 22B-1 of the lid 22 opposed to the concave part 21B-1 of the case body 21. Similarly, the negative electrode lead 4b was in contact with a portion 5b which was a part of the thermoplastic resin layer 5 and covered the bottom face of the concave part 21B-2 of the case body 21, and a portion 6₂ which was a part of the thermoplastic resin layer 6 and covered the surface of a portion 22B-2 of the lid 22 opposed to the concave part 21B-2 of the case body 21. A part of the positive electrode lead 4a was exposed through the opening part 21Cₐ formed in the lead-sandwiching part 2B₁. Similarly, a part of the negative electrode lead 4b was exposed through the opening part 21C_{b} formed in the lead-sandwiching part 2B₂.

Next, the circumference of the housing part 2A of the case 2 including the lead-sandwiching parts 2B₁ and 2B₂ was heated. Thus, the case body 21 was heat-sealed to the lid 22 via the thermoplastic resin layer 5 and the thermoplastic resin layer 6 which is being in contact with the thermoplastic resin layer 5. The positive electrode lead 4a was heat-sealed to the periphery of the opening part 21Cₐ of the first zone 21B₁ by the portion 5a of the thermoplastic resin layer 5 and the insulating ring 5a′. Furthermore, the second zone 22B₁ of the lid 22 was heat-sealed to the positive electrode lead 4a via the portion 6₁ of the thermoplastic resin layer 6 included in the second zone 22B₁. Similarly, the negative electrode lead 4b was heat-sealed to the periphery of the opening part 21C_{b} of the first zone 21B₂ by the thermoplastic resin layer 5b and the insulating ring 5b′. Furthermore, the second zone 22B₂ of the lid 22 was heat-sealed to the negative electrode lead 4b via the portion 6₂ of the thermoplastic resin layer 6 included in the second zone 22B₂.

Next, the four open ends of the case 2 were subjected to seam welding, to form the four sealed parts 2C shown in FIGS. 19 and 2, thereby the electrode group 3 was housed in the case 2. And then, the electrode group 3 housed in the case was vacuum-dried at 80° C. for 24 hours.

[Preparation of Nonaqueous Electrolyte]

A mixed solvent was prepared by mixing ethylene carbonate (EC) and diethyl carbonate (DEC) in a volume ratio of 1:2. A liquid nonaqueous electrolyte was prepared by dissolving lithium hexafluorophosphate (LiPF₆) in a concentration of 1.2 mol/L as an electrolyte in the mixed solvent.

[Injection of Nonaqueous Electrolyte and Completion of Nonaqueous Electrolyte Battery]

A nonaqueous electrolyte was injected through the inlet (not shown) formed in the concave part 21A of the case body 21 of the case 2.

Finally, the inlet (not shown) formed in the concave part 21A of the case body 21 of the case 2 was sealed, to obtain a nonaqueous electrolyte battery 1 having a capacity of 15 Ah of the Example.

The housing part 2A of the nonaqueous electrolyte battery 1 of the Example had a rectangular plane shape of 150 mm×110 mm (excluding a corner part) in outer dimensions. The housing part 2A had a height of 15 mm as an outer dimension. The distance between one edge side 21A-1 of the concave part 21A of the case body 21 constituting the housing part 2A of the nonaqueous electrolyte battery 1 of Example and the sealed part 2C opposed to the edge side 21A-1 was 20 mm. Similarly, the distance between the other edge side 21A-2 of the concave part 21A of the case body 21 and the sealed part 2C opposed to the edge side 21A-2 was also 20 mm.

### Comparative Example 1

In Comparative Example 1, a nonaqueous electrolyte battery 1 was prepared in the same manner as in Example except for the following points.

In Comparative Example 1, there was provided a case in which opening parts corresponding to opening parts 21Cₐ and 21C_{b} shown in FIGS. 1, 2, and 5 were not formed.

Furthermore, in Comparative Example 1, a thermoplastic resin layer 5 and a thermoplastic resin layer 6 opposed to each other were heat-sealed, and a lead-sandwiching part of the case was then perforated, to form a through-hole passing through the lead-sandwiching part and a positive electrode lead grasped by the lead-sandwiching part, and a through-hole passing through the lead-sandwiching part and a negative electrode lead grasped by the lead-sandwiching part. Then, a hollow gasket was inserted so as to be in contact with a portion of the through-hole passing through the case. Next, a rod-shaped member made of aluminum was inserted into one of the through-holes so as to pass through a hollow portion of the hollow gasket and be in contact with the positive electrode lead. Similarly, a rod-shaped member made of aluminum was inserted into the other through-hole so as to pass through a hollow portion of the hollow gasket and be in contact with the negative electrode lead. Finally, each of the inserted rod-shaped members was fixed with nuts from the upper and lower sides of the case. Thus, a nonaqueous electrolyte battery of Comparative Example 1 was obtained.

That is, in the nonaqueous electrolyte battery 1 of Comparative Example 1, the case excluded the lead-sandwiching parts 2B₁ and 2B₂ included in the case 2 of the nonaqueous electrolyte battery 1 of the Example. That is, the case excluded a lead-sandwiching part 2B₁ grasping a positive electrode lead 4a between a first zone 21B₁ and a second zone 22B₁ so that at least a part of the positive electrode lead 4a was exposed through an opening part 21Cₐ, and a lead-sandwiching part 2B₂ grasping a negative electrode lead 4b between a first zone 21B₂ and a second zone 22B₂ so that at least a part of the negative electrode lead 4b was exposed through an opening part 21C_{b}.

### Comparative Example 2

In Comparative Example 2, a nonaqueous electrolyte battery 1 was prepared in the same manner as in the Example except for the following points.

In the nonaqueous electrolyte battery of Comparative Example 2, each of a positive electrode lead and a negative electrode lead and a thermoplastic resin layer covering a lid body were not in contact with each other, and thereby a space was formed between each of the positive electrode lead and the negative electrode lead and the thermoplastic resin layer covering the lid.

That is, in the nonaqueous electrolyte battery of Comparative Example 2, a case excluded the lead-sandwiching parts 2B₁ and 2B₂ included in the case 2 of the nonaqueous electrolyte battery 1 of the Example. That is, the case excluded a lead-sandwiching part 2B₁ grasping a positive electrode lead 4a between a first zone 21B₁ and a second zone 22B₁ so that at least a part of the positive electrode lead 4a was exposed through an opening part 21Cₐ, and a lead-sandwiching part 2B₂ grasping a negative electrode lead 4b between a first zone 21B₂ and a second zone 22B₂ so that at least a part of the negative electrode lead 4b was exposed through an opening part 21C_{b}.

### Comparative Example 3

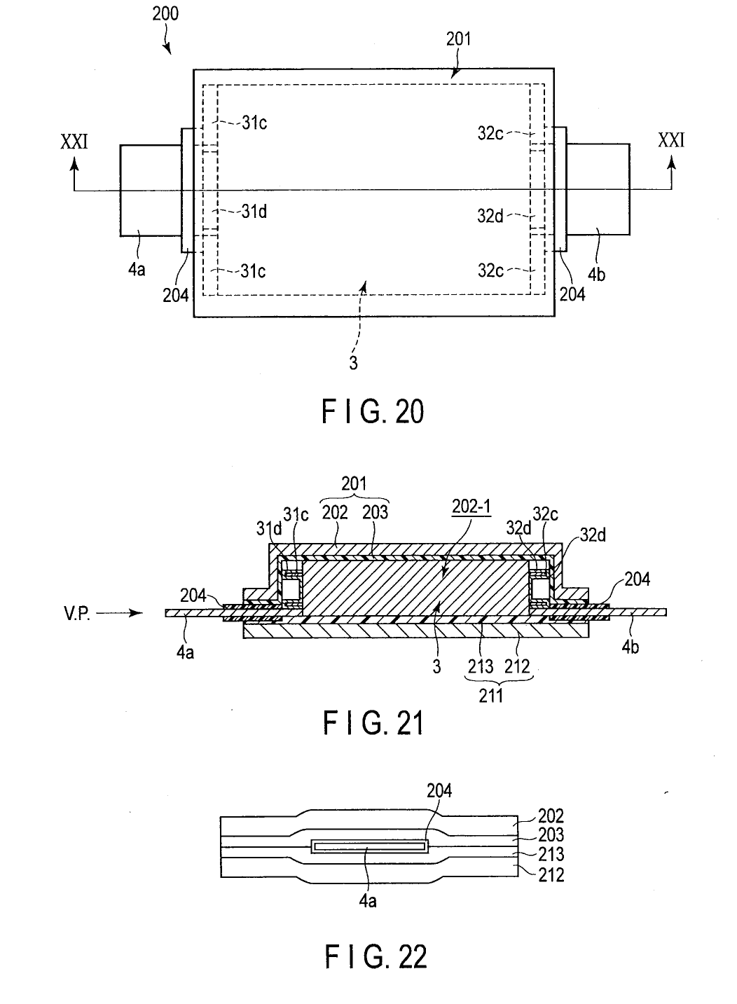

In Comparative Example 3, a nonaqueous electrolyte battery 200 shown in FIGS. 20 to 22 was prepared by the following method.

FIG. 20 is a schematic plan view of a nonaqueous electrolyte battery of Comparative Example 3. FIG. 21 is a schematic sectional view taken along line XXI-XXI of the nonaqueous electrolyte battery shown in FIG. 20. FIG. 22 is a schematic side view of the nonaqueous electrolyte battery shown in FIGS. 20 and 21, and observed from an observation direction v.p. shown in FIG. 21.

First, an electrode group 3 was prepared in the same manner as in the Example. Then, a positive electrode lead 4a was connected to a current collecting tab 31d of the positive electrode 31 of the electrode group 3 in the same manner as in Example. A negative electrode lead 4b was connected to a current collecting tab 32d of the negative electrode 32 of the electrode group 3 in the same manner as in Example.

Next, two stainless steel laminate films, 201 and 211, were prepared.

The stainless steel laminate film 201 included stainless steel 202 and a thermoplastic resin layer 203 stacked on the stainless steel 202.

The stainless steel 202 included a cup part 202-1 formed by deep drawing processing and being capable of housing the electrode group 3 previously prepared. The thermoplastic resin layer 203 conformally covered the stainless steel 202 so as to cover the inner surface of the cup part 202-1.

The stainless steel laminate film 211 included stainless steel 212 and a thermoplastic resin layer 213 stacked on the stainless steel 212. The stainless steel laminate film 211 was a plate-like member having the same plane shape as that of the stainless steel laminate film 201.

Next, the electrode group 3 was housed in a cup part 201-1 of the stainless steel laminate film 201.

Then, the stainless steel laminate films 201 and 211 were opposed to each other so that a part of the thermoplastic resin layer 203 of the stainless steel laminate film 201 and a part of the thermoplastic resin layer 213 of the stainless steel laminate film 211 were in contact with each other. In this case, as shown in FIGS. 20 to 22, the positive electrode lead 4a connected to the electrode group 3 was sandwiched between the thermoplastic resin layers 203 and 213 with a resin layer 204 interposed between the positive electrode lead 4a and the thermoplastic resin layer 203 and between the positive electrode lead 4a and the thermoplastic resin layer 213. Similarly, the negative electrode lead 4b connected to the electrode group 3 was sandwiched between the thermoplastic resin layers 203 and 213 with a resin layer 204 was interposed between the negative electrode lead 4b and the thermoplastic resin layer 203 and between the negative electrode lead 4b and the thermoplastic resin layer 213. A resin layer including a heat-resistant layer and an adhesion layer was used as the resin layer 204. As shown in FIG. 21, a part of each of the resin layer 204 was extended from the stainless steel laminate films 201 and 211.

Next, heat was applied to the edge parts of the stainless steel laminate films 201 and 211 opposed to each other, to heat-seal the thermoplastic resin layers 203 and 213 being in contact with each other. Simultaneously, the positive electrode lead 4a was heat-sealed to the thermoplastic resin layer 213 and the resin layer 204 being in contact with the positive electrode lead 4a. Similarly, the negative electrode lead 4b was heat-sealed to the thermoplastic resin layer 213 and the resin layer 204 being in contact with the negative electrode lead 4b. Furthermore, the resin layer 204 was heat-sealed to the thermoplastic resin layers 203 and 213 being in contact with the resin layer 204.

Thus, the nonaqueous electrolyte battery 200 shown in FIGS. 20 to 22 was prepared.

When the nonaqueous electrolyte battery 200 was observed from the observation direction v.p. shown in FIG. 21, a shape shown in FIG. 22 could be observed. That is, in the nonaqueous electrolyte battery 200, the stainless steels 202 and 212 of the stainless steel laminate films 201 and 211, and the thermoplastic resin layers 203 and 213 which grasp the positive electrode lead 4a and the resin layer 204 were deformed by the sizes of the positive electrode lead 4a and the resin layer 204. Although not shown in the figures, the stainless steels 202 and 212 of the stainless steel laminate films 201 and 211, and the thermoplastic resin layers 203 and 213 which grasp the negative electrode lead 4b and the resin layer 204 were also deformed as in those shown in FIG. 22.

The cup part 202-1 of the nonaqueous electrolyte battery 200 of Comparative Example 3 had a plane shape of 150 mm×110 mm (excluding a corner part R2) in outer dimensions. The cup part 202-1 had a height of 15 mm in an outer dimension.

[Evaluation]

Capacity Measurement

Charging and discharging of each of the nonaqueous electrolyte batteries of the Example, Comparative Example 1, Comparative Example 2, and Comparative Example 3 were performed once in an environment of 25° C. at a 1 C rate, and a first discharging capacity was measured. The results are shown in Table 1.

Durability Test

There were prepared 50 nonaqueous electrolyte batteries 1 for each of the Example, Comparative Example 1, Comparative Example 2, and Comparative Example 3. The thickness of each battery in a state of a 50% charged amount (SOC 50%) under an environment of 25° C. was measured. Then, the battery was stored in a thermohygrostat controlled to a temperature of 60° C. and a humidity of 93% for three months. The battery after storing was taken out from the thermohygrostat, and left under an environment of 25° C. The temperature of the battery was returned to 25° C., and the thickness of the battery was then measured. The average increasing rate of the thickness of the battery, (thickness of battery after storing−thickness of battery before storing)/(thickness of battery before storing), was also expressed in Table 1. Each battery after storing was discharged at a 1 C rate, and charging and discharging of the battery then were performed once under an environment of 25° C. at a 1 C rate. The obtained discharged capacity was defined as the recovery capacity, and the average recovery capacity rate, (recovery capacity/first discharging capacity)×100, was also expressed in Table 1.

TABLE 1

| | | Increasing | |
|---|---|---|---|
| | First | Rate of | Recovery |
| | Discharging | Thickness of | Capacity |
| | Capacity | Battery | Rate |
| | (Ah) | (%) | (%) |
| Example | 15.2 | less than 2 | 97 |
| Comparative | 15.0 | 51 | 68 |
| Example 1 | | | |
| Comparative | 15.1 | 32 | 70 |
| Example 2 | | | |
| Comparative | 15.0 | not less than | 40 |
| Example 3 | | 100 | |

From the results of Table 1, it is found that the increasing rate of the thickness in the nonaqueous electrolyte battery 1 of the Example is smaller than that in the nonaqueous electrolyte batteries 1 of Comparative Example 1, Comparative Example 2, and Comparative Example 3, and the nonaqueous electrolyte battery 1 of Example suppresses the generation of gas in the battery. It is found that the battery of the Example has a high recovery capacity rate and shows excellent durability. This is because the lead-sandwiching parts 2B₁ and 2B₂ of the case 2 in the nonaqueous electrolyte battery 1 of the Example can prevent the infiltration of moisture into the case 2, and thus prevent moisture reaching the electrode group 3 housed in the housing part 2A of the case 2, which can prevent deterioration of the electrode group 3 over a long period.

In the nonaqueous electrolyte battery 1 of the Example, the lead-sandwiching part 2B₁ had the opening part 2Cₐ, and the lead-sandwiching part 2B₂ had the opening part 2C_{b}. However, the periphery of the opening part 2Cₐ was heat-sealed to the positive electrode lead 4a by the thermoplastic resin layer 5a and the insulating ring 5a′. The periphery of the opening part 2C_{b} was heat-sealed to the negative electrode lead 4b by the thermoplastic resin layer 5b and the insulating ring 5b′. Since these heat seals had an excellent sealing property, the heat seals could further prevent infiltration of moisture into the case 2, and thus prevent moisture reaching the electrode group 3 housed in the housing part 2A of the case 2. This is another reason why the nonaqueous electrolyte battery 1 of Example can show excellent durability.

Furthermore, the four sealed parts 2C of the case 2 subjected to seam welding in the nonaqueous electrolyte battery 1 of Example could further prevent infiltration of moisture into the case 2. This is a further reason why the nonaqueous electrolyte battery 1 of Example 1 can show excellent durability.

On the other hand, the nonaqueous electrolyte battery 1 of Comparative Example 1 had durability lower than that of the nonaqueous electrolyte battery of the Example. This result is considered to be caused by the following phenomenon. The nonaqueous electrolyte battery 1 of Comparative Example 1 has a through-hole passing through the heat seal, and thereby the sealing property of the heat seal is impaired by the generated stress. This causes the infiltration of moisture into the case.

The nonaqueous electrolyte battery 1 of Comparative Example 2 also had durability lower than that of the nonaqueous electrolyte battery of the Example. This result is considered to be caused by the following phenomenon. The nonaqueous electrolyte battery 1 of Comparative Example 2 has a space formed between the positive electrode lead and the lid and a space formed between the negative electrode lead and the lid. Moisture can pass through the spaces and reach the electrode group 3.

The nonaqueous electrolyte battery 200 of Comparative Example 3 also had durability lower than that of the nonaqueous electrolyte battery of the Example. This result is considered to be caused by the following phenomenon. The edge parts of the stainless steel laminate films 201 and 211 from which the positive electrode lead 4a and the negative electrode lead 4b extend are deformed as shown in FIG. 22, and a clearance is slightly formed between the heat-sealed portions of the thermoplastic resin layers 203 and 213. Therefore, moisture can pass through the clearance, and reach the electrode group 3.

Thus, since the nonaqueous electrolyte battery 1 of Example showed more excellent durability than those of Comparative Example 1, Comparative Example 2, and Comparative Example 3, the nonaqueous electrolyte battery 1 could exhibit a long useful life.

According to at least one embodiment and the Example described above, the nonaqueous electrolyte battery can prevent moisture contact occurring in the electrode group housed in the case. This means that deterioration of the nonaqueous electrolyte battery can be prevented. Therefore, the nonaqueous electrolyte battery can exhibit a long useful life. Furthermore, the nonaqueous electrolyte battery according to the first embodiment can easily and certainly obtain electrical connection between the nonaqueous electrolyte battery and an electronic device and/or other battery through the portion of the electrode lead exposed through the opening part of the lead-sandwiching part.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nonaqueous electrolyte battery comprising:
an electrode group;
an electrode lead electrically connected to the electrode group;
a case comprising a housing part housing the electrode group, a sealed part formed in a peripheral portion of the case, and a lead-sandwiching part positioned between the housing part and the sealed part, the lead-sandwiching part comprising a first zone and a second zone and sandwiching the electrode lead between the first zone and the second zone; and
a nonaqueous electrolyte;
wherein at least one of the first zone and the second zone of the lead-sandwiching part comprises an opening part, and at least a part of the electrode lead is exposed through the opening part.

2. The nonaqueous electrolyte battery according to claim 1, wherein the electrode lead is heat-sealed to a periphery of the opening part of the lead-sandwiching part.

3. The nonaqueous electrolyte battery according to claim 1, wherein the first zone of the lead-sandwiching part comprises a first insulating member being in contact with the electrode lead, and the second zone of the lead-sandwiching part comprises a second insulating member being in contact with the electrode lead.

4. The nonaqueous electrolyte battery according to claim 1, wherein the sealed part is sealed by seam welding.

5. The nonaqueous electrolyte battery according to claim 1, wherein the case comprises at least one selected from the group consisting of stainless steel, stainless steel with nickel-plating, and a nickel-plated steel plate.

6. The nonaqueous electrolyte battery according to claim 1, wherein the nonaqueous electrolyte is a liquid nonaqueous electrolyte.

7. The nonaqueous electrolyte battery according to claim 1, wherein the electrode group comprises a negative electrode and a positive electrode, and the negative electrode comprises at least one selected from the group consisting of lithium titanate having a spinel structure, titanium oxide having a bronze structure (B), titanium oxide having an anatase structure, and lithium titanate having a ramsdellite structure.

8. The nonaqueous electrolyte battery according to claim 7, the negative electrode comprises lithium titanate having a spinel structure.

9. A battery module comprising:
at least two nonaqueous electrolyte batteries according to claim 1; and
a bus bar electrically connected between a portion of the electrode lead of one of the at least two nonaqueous electrolyte battery and a portion of the electrode lead of another of the at least two nonaqueous electrolyte battery, each of the portions being exposed through the opening part of the lead-sandwiching part.

10. A battery apparatus comprising:
the battery module according to claim 9; and
an outer case housing the battery module.
